(19) United States
(12) Patent Application Publication
(10) Pub. No.: US 2026/0071146 A1
(43) Pub. Date: Mar. 12, 2026

(54) DISH CLEANING AND/OR DISH RINSING COMPOSITION WITH IMPROVED FINISHING PROPERTIES

(71) Applicant: SYMRISE AG, Holzminden (DE)

(72) Inventors: Tony BARTOLINI, Herblay-sur-Seine (FR); Anne-Laure AZAIS, Poissy (FR)

(21) Appl. No.: 19/123,844

(22) PCT Filed: Oct. 25, 2023
(86) PCT No.: PCT/EP2023/079733

§ 371 Date: Apr. 24, 2025

(30) Foreign Application Priority Data
Oct. 25, 2022 (WO) PCT/EP2022/079778

(51) Int. Cl. C11D 3/20; C11D 1/72; C11D 3/22; C11D 3/33; C11D 3/34; C11D 3/37; C11D 3/386; C11D 3/48; C11D 17/00

(52) U.S. Cl. CPC C11D 3/2044; C11D 1/72; C11D 3/2065; C11D 3/2072; C11D 3/2086; C11D 3/2093; C11D 3/222; C11D 3/33; C11D 3/3409; C11D 3/3765; C11D 3/386; C11D 3/48; C11D 17/0091; C11D 2111/14

(57) ABSTRACT

The present invention is in the field of detergents. In particular, it relates to a dish cleaning and dish rinsing composition for automatic dish washing comprising specific hydroxyl compounds with the ability to improve the cleaning and/or drying performance of standard dishwashing products and/or their use as dish cleaning and/or dish rinsing product for use in automatic dishwashing and/or as anti-spotting agents or compositions, respectively.

### TECHNICAL FIELD OF THE INVENTION

The present invention refers generally to the field of detergents and cleaning compositions. In particular, it relates to dish cleaning and dish rinsing compositions comprising specific hydroxyl compounds with the ability to improve the cleaning and/or drying performance of standard dishwashing products and/or their use as dish cleaning and dish rinsing product for use in automatic dishwashing. These products are usually referred to as 2-in-1 products. Moreover, the present invention relates to a dish rinsing formulation, i.e. a so-called rinse aid.

More specifically, the present invention refers to a combined dish cleaning and dish rinsing composition as well as a dish rinsing composition (so-called rinse aid) for use in automatic dishwashing, comprising or consisting of at least one surfactant as specified herein and an effective amount of a specific type of boosting agents, such as alkanediols, glyceryl caprylate, 4-hydroxyacetophenone, ethyl hexyl glycerin and/or tropolone, and the use of said compositions in, or as dishwashing, dish cleaning and/or dish rinsing product as well as for the preparation of the corresponding dish cleaning and/or dish rinsing products. Additionally, the present invention relates to the use of a specific type of boosting agents, such as alkanediols, glyceryl caprylate, 4-hydroxyacetophenone, ethyl hexyl glycerin or tropolone as well as any mixtures of these boosting agents, in an effective amount for reducing deposits and/or water spotting on dishes and/or as anti-spotting agents or compositions, respectively. Furthermore, the present invention relates to dish cleaning and/or dish rinsing products as such comprising or consisting of the compositions according to the present invention. Finally, the present invention relates to a method for efficiently reducing deposits and/or water spotting on dishes in a dish cleaning and/or dish rinsing composition by adding an effective amount of specific boosting agents, such as alkanediols, glyceryl caprylate, 4-hydroxyacetophenone, ethyl hexyl glycerin and/or tropolone to said dish cleaning and/or dish rinsing composition.

### BACKGROUND OF THE INVENTION AND PRIOR ART

Dishwashing liquids or washing-up liquids are surfactant-based detergents that can be found in practically every household around the world. However, manual dishwashing has mainly been superseded by the use of automatic dishwashing machines, particularly in terms of convenience and hygiene, especially in the wake of ever-increasing industrialization and mechanization. An automatic dishwasher combines the steps of cleaning, rinsing and drying of the washed items.

However, this involves using a special dishwashing detergent intended for washing dishes in the automated dishwasher. Unfortunately, not all detergents are compatible with all materials such as brass, stainless steel or some plastics, wood or fine glassware and often cause the formation of droplet deposits (so-called ‘spotting’) upon drying, which are particularly visible on the surface of transparent tableware such as glass or stainless-steel surfaces. These mineral deposits (also called spotting or filming) are caused by evaporation of water droplets remaining on the washed items during the drying process resulting in a less clean/hygienic, less shiny and less appealing appearance.

In order to reduce the droplet formation and thus also to improve the drying performance usually so-called rinse aids or rinsing agents (dish rinsing compositions) are used after washing step in a subsequent rinsing step which often contain non-ionic surfactants that reduce the surface tension of the water, allowing it to run off the item without drop of film formation. Many dishwashing products are sold as multiphase products, combining wash-active ingredients with such rinse aids. These compositions or formulations are usually referred to as 2-in-1 products or multiphase products or (combined) dish washing and rinsing compositions. However, commonly used rinsing products are in most cases not sufficient to achieve a good drying performance and/or to prevent the formation of mineral deposits, i.e. spotting, especially in view of plastic-based items, stainless steel items and glassware.

Thus, in the past years several attempts were made to further improve the cleaning results and the final appearance of the washed goods when using an automatic dishwasher. For this purpose, several new dishwashing compositions were developed which comprise a plurality of different additional ingredients which end up in rivers, lakes and oceans causing environmental damage as they are difficult to biodegrade and therefore accumulate in the environment. Other ingredients are not considered to not be safe for health.

It is for example known that non-ionic surfactants are not only good cleaning agents but that they additionally lower the surface tension of the water and thus reduce the formation of droplet spotting upon drying. However, in order to further optimize the anti-spotting performance further, rather complex, compositions are required, and surfactants are considered ambiguous under environmental aspects as they can cause serious environmental pollution and might have a toxic effect on living organisms.

Accordingly, it is also an aim to further reduce the overall amount of surfactants in such multiphase products (i.e. in combined dish cleaning and rinsing compositions) or in the rinse aids (i.e. in dish rinsing compositions).

WO 2002/034870 A1 discloses a combination of hydrophobically modified polycarboxylates, acrylic acid (co)polymers and phosphonates to achieve an anti-spotting effect.

EP 2 622 054 B1 suggests the use of a combination of at least one cationic guar, cationic guar ether or cationic guar ester having a molecular weight of less than 1,000,000 g/mol to eliminate, limit or prevent the spotting and/or filming phenomena.

EP 2 201 090 B1 relates to a composition based on a mixture of hydrophobically modified polycarboxylates and hydrophilically modified polycarboxylates.

However, all of these approaches require the use of multiple ingredients which accumulate in the environment and/or are not considered to be safe for health. Moreover, in all these compositions the surfactant content is high. Thus, there is still an ongoing need to further improve the complex cleaning and rinsing properties of dishwashing compositions in order to fulfil the demanding expectations on the part of the end consumers. The detergent industry is permanently searching for new ingredients which can improve these negative aspects, especially in view of automatic dishwashing.

Thus, there is need for efficient dish cleaning and/or dish rinse compositions which are less complex and thus involve less ingredients, which are cheap, highly effective and which avoid or at least reduce the use of such unfavorable ingredients under environmental and health aspects.

Additionally, the products have to meet the heightened consumer expectations in terms of enhance cleanliness and shine with no spotting and/or filming.

Therefore, it has been the object of the present invention to provide for additives for dish cleaning and/or dish rinsing, preferably for use in an automatic dishwasher, that improve the cleaning performance and simultaneously reduce spotting upon drying and deliver high shine, and preferably, for efficient dish cleaning and/or dish rinsing compositions as such.

Another object of the present invention is the reduction of chemicals required to provide for an efficient dish cleaning and/or dish rinsing formulation and thus also the reduction of the amount of surfactants in such detergents and other cleaning products or rinse aids which are discharged into sewage systems or directly into surface waters after use.

Finally, it is another object of the present invention, to provide for new anti-spotting substances/agents/compositions and thus also for new rinse aid formulations or compositions/products.

Surprisingly it has been found that the combination of an effective amount of 1,2-heptanediol or 2,3-heptanediol or a mixture comprising 1,2-heptanediol and 2,3-heptanediol or a specific type of other boosting agents, such as alkanediols, glyceryl caprylate, 4-hydroxyacetophenone, ethyl hexyl glycerin and/or tropolone as specified herein, with surfactants efficiently improves the cleaning and rinsing/drying performance in a synergistical manner resulting in considerably reduced spotting after drying thereby providing for a more clean/hygienic, more shiny and more appealing appearance of the washed items compared to corresponding compositions without said compounds. Additionally, based on the superior efficiency of the dish cleaning and/or dish rinsing compositions presented herein, the overall amount of surfactants and other ingredients can be reduced to at least achieve a similar cleaning and/or rinsing effect.

Surprisingly, it has been found that the addition of an effective amount of 1,2-heptanediol or 2,3-heptanediol or a mixture comprising 1,2-heptanediol and 2,3-heptanediol or a specific type of boosting agents, such as alkanediols, glyceryl caprylate, 4-hydroxyacetophenone, ethyl hexyl glycerin and/or tropolone, as defined herein, to a dish cleaning and/or rinsing composition, improves the cleaning performance and/or improves the drying performance thereby providing considerably reduced water spotting after drying, resulting in an improved cleanliness and spot-free appearance.

Thus, the dish cleaning and/or dish rinsing compositions which contain a surfactant or a mixture of surfactants in combination with 1,2-heptanediol or 2,3-heptanediol or a mixture comprising 1,2-heptanediol and 2,3-heptanediol or a specific type of boosting agents, such as alkanediols, glyceryl caprylate, 4-hydroxyacetophenone, ethyl hexyl glycerin and/or tropolone, as defined herein, exhibit improved overall performances over dish cleaning and/or dish rinsing compositions without such a boosting agent or mixture of boosting agents.

Conversely, also because of the boosting effect, the amount of surfactants and other (cleaning and/or rinsing) ingredients in these dish cleaning and/or rinsing compositions can be reduced to achieve a similar cleaning effect, i.e. without loss of cleaning performance and/or rinsing/drying performance while simultaneously allowing for an efficient anti-spotting effect along with an improved drying performance.

### SUMMARY OF THE INVENTION

The present invention was made in view of the disadvantages described above. To solve the above-mentioned drawbacks, the present invention provides an efficient dish cleaning and/or dish rinsing composition that noticeably improves the cleaning and appearance of dishes as well as a method for reducing deposits, i.e. enhancing the cleanliness and/or reducing water spotting on dishes, i.e. improving the shine and transparency of dishes. More specifically, the present invention provides for an efficient dish cleaning and rinsing composition, i.e. a formulation combining cleaning and rinsing properties (2-in-1 composition or multiphase composition). In addition, the present invention provides for an efficient dish rinsing composition (rinse aid) which is usually used after the washing step in automatic dishwashing. Both compositions are based on the advantageous and synergistic combination of at least one surfactant and at least one boosting agent (at least one alkanediol as specified herein, glyceryl caprylate, 4-hydroxyacetophenone, ethyl hexyl glycerin and/or tropolone).

Preferably, the dish cleaning and rinsing compositions according to the present invention can be used as combined dish cleaning and rinsing products or can be used for the preparation of such combined products. Suitable applications are for example the use in or as multi-benefit detergents (multiphase products) like automatic dishwashing gels or liquids, powders and tablets which combine the cleaning as well as the rinsing components in one product formulation or one multi-compartment product. The dish cleaning and rinsing compositions according to the present invention combine the benefits of improved cleaning performance, improved rising performance, and improved drying performance in one product. Preferably, these compositions are used in automatic dishwashing (machine dishwashing).

Preferably, the dish rinsing compositions according to the present invention are used in or as rinse aid products or as anti-spotting agents. The dish rinsing compositions according to the present invention can be used in combination with commercially available dish cleaning detergents in a subsequent rinsing step. Preferably, these compositions are used in automatic dishwashing (machine dishwashing).

Thus, according to another preferred variant, the dish rinsing compositions according to the present invention are used as rinse aids.

In order to accomplish the above problems, the present invention provides in one aspect a dish cleaning and rinsing composition for automatic dishwashing, comprising or consisting of:
(a1) 1,2-heptanediol;
(b1) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c1) optionally at least one enzyme or an enzyme formulation, comprising at least one enzyme;
or
(a2) 2,3-heptanediol;
(b2) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c2) optionally at least one enzyme or an enzyme formulation, comprising at least one enzyme;
or
(a3) a mixture comprising 1,2-heptanediol and 2,3-heptanediol;
(b3) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c3) optionally at least one enzyme or an enzyme formulation, comprising at least one enzyme.

Preferably, the dish cleaning and rinsing composition for automatic dishwashing comprises an additional enzyme component (c1, c2, c3).

In another aspect, the present invention relates to a dish rinsing composition (preferably for automatic dishwashing) comprising or consisting of:
(a1) 1,2-heptanediol; and
(b1) at least one surfactant;
or
(a2) 2,3-heptanediol; and
(b2) at least one surfactant;
or
(a3) a mixture comprising 1,2-heptanediol and 2,3-heptanediol; and
(b3) at least one surfactant.

According to a further aspect the present invention relates to a dish cleaning and rinsing composition for automatic dishwashing, comprising or consisting of:
(a) at least one boosting agent selected from the group consisting of:
   (a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (a^{II}) glyceryl caprylate;
   (a^{III}) 4-hydroxyacetophenone;
   (a^{IV}) ethyl hexyl glycerin;
   (a^{V}) tropolone; and
   any mixtures thereof;
(b) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c) optionally at least one enzyme or an enzyme formulation comprising at least one enzyme.

Preferably, the dish cleaning and rinsing composition for automatic dishwashing comprises an additional enzyme component (c).

According to a further aspect the present invention relates to a dish rinsing composition (preferably for automatic dishwashing), comprising or consisting of:
(a) at least one boosting agent selected from the group consisting of:
   (a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (a^{II}) glyceryl caprylate;
   (a^{III}) 4-hydroxyacetophenone;
   (a^{IV}) ethyl hexyl glycerin;
   (a^{V}) tropolone; and
   any mixtures thereof;
(b) at least one surfactant.

According to another aspect the present invention relates to the use of 1,2-heptanediol or 2,3-heptanediol or a mixture comprising 1,2-heptanediol and 2,3-heptanediol or at least one boosting agent (a) selected from the group consisting of:
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
(a^{II}) glyceryl caprylate;
(a^{III}) 4-hydroxyacetophenone;
(a^{IV}) ethyl hexyl glycerin;
(a^{V}) tropolone; and
any mixture thereof;
for reducing deposits and/or water spotting on dishes and/or as anti-spotting agent and/or as rinse aid.

According to a further aspect the present invention relates to the use of 1,2-heptanediol or 2,3-heptanediol or a mixture comprising 1,2-heptanediol and 2,3-heptanediol or at least one boosting agent (a) selected from the group consisting of:
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
(a^{II}) glyceryl caprylate;
(a^{III}) 4-hydroxyacetophenone;
(a^{IV}) ethyl hexyl glycerin;
(a^{V}) tropolone; and
any mixture thereof; and
(b) at least one surfactant;
for reducing deposits and/or water spotting on dishes and/or as anti-spotting agent and/or as rinse aid.

Preferably, the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols.

In a preferred embodiment the present invention further relates to the use of the dish cleaning and/or dish rinsing composition according to the invention as dish cleaning and/or dish rinsing product, or for the preparation of a corresponding dish cleaning and/or dish rinsing product, preferably as, or for the preparation of a combined dish cleaning and rinsing product or a rinse aid. More specifically, the present invention further relates to the use of the dish cleaning and rinsing composition according to the invention as, or for the preparation of a dish cleaning and rinsing product, preferably a multiphase product, or to the use of the dish rinsing composition according to the invention as, or for the preparation of a dish rinsing product such as a rinse aid.

Furthermore, the present invention relates to a dish cleaning and/or dish rinsing product as such comprising or consisting of the dish cleaning and/or rinsing composition according to the invention, preferably wherein the product is an automatic dishwashing product, and further preferred a combined dish cleaning and rinsing product or a rinsing product. More specifically, the present invention relates to a dish cleaning and rinsing product as such comprising or consisting of the dish cleaning and rinsing composition according to the invention for automatic dishwashing or to a dish rinsing product such as a rinse aid as such comprising or consisting of the dish rinsing composition according to the invention for automatic dishwashing.

Additionally, in a preferred embodiment the present invention relates to a product, wherein the product is selected from the group consisting of detergents, such as dishwashing detergents, rinsing products such as rinse aids, combined multiphase products, and mixtures thereof, each of the aforementioned in liquid, granule, powder, bar, paste, spray, tablet, gel, or foam form, and optionally in two-compartment or multi-compartment form.

Finally, the present invention relates to a method of reducing deposits and/or water spotting on dishes, comprising the steps of:
(i) providing a dish cleaning and rinsing composition comprising at least one surfactant or dish rinsing composition comprising at least one surfactant; and
(ii) adding thereto an effective amount of 1,2-heptanediol or 2,3-heptanediol or a mixture comprising 1,2-heptanediol and 2,3-heptanediol or at least one boosting agent (a) selected from the group consisting of:
   (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
   (a^{II}) glyceryl caprylate;
   (a^{III}) 4-hydroxyacetophenone;
   (a^{IV}) ethyl hexyl glycerin;
   (a^{V}) tropolone; and
   any mixture thereof.

Accordingly, in one variant the present invention relates to a method of reducing deposits and/or water spotting on dishes, comprising the steps of:
(i) providing a dish cleaning and rinsing composition, comprising at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(ii) adding thereto an effective amount of 1,2-heptanediol or 2,3-heptanediol or a mixture comprising 1,2-heptanediol and 2,3-heptanediol or at least one boosting agent (a) selected from the group consisting of:
   (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
   (a^{II}) glyceryl caprylate;
   (a^{III}) 4-hydroxyacetophenone;
   (a^{IV}) ethyl hexyl glycerin;
   (a^{V}) tropolone; and
   any mixture thereof.

Moreover, in another variant the present invention relates to a method of reducing deposits and/or water spotting on dishes, comprising the steps of:
(i) providing a dish rinsing composition, comprising at least one surfactant; and
(ii) adding thereto an effective amount of 1,2-heptanediol or 2,3-heptanediol or a mixture comprising 1,2-heptanediol and 2,3-heptanediol or at least one boosting agent (a) selected from the group consisting of:
   (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
   (a^{II}) glyceryl caprylate;
   (a^{III}) 4-hydroxyacetophenone;
   (a^{IV}) ethyl hexyl glycerin;
   (a^{V}) tropolone; and
   any mixture thereof.

It was surprisingly found that that a combination at least one boosting agent (a) as defined herein, such as an alkanediol, glyceryl caprylate, 4-hydroxyacetophenone, ethyl hexyl glycerin or tropolone, and surfactants results in improved cleaning properties and an improved drying performance with enhanced anti-spotting properties based on the synergistic interaction of said components.

The inventive composition is highly suitable for use in or as dishwasher composition which combines both, excellent cleaning and rinsing properties, and which simultaneously is based on a considerably reduced list of ingredients and thus avoids use of substances which pollute the environment unnecessarily. Accordingly, the dish cleaning and rinsing composition according to the present invention is highly suitable as multiphase product for automatic dishwashing. Also the dish rinsing product is highly suitable as rinse aid in automatic dishwashing. Based on the synergistic interaction between the boosting component (a) and the surfactant component (b) it is possible to further reduce the overall surfactant content while achieving efficient cleaning and/or rinsing performances.

Thus, the inventive composition shows improved washing and/or rinsing properties while simultaneously reducing the proportions of the other detergents and rinse agents required.

The compositions described herein are particularly suitable for the incorporation into commercially available dish cleaning and/or rinsing compositions. However, it was further surprisingly found, that the compositions of the invention as such are excellent dish cleaning and rinsing compositions or rinse aids which provide improved cleaning and/or rinsing properties, meaning improved drying performances with considerably reduces water spotting. The dish cleaning and/or rinsing compositions according to the present invention provide for superior glassware appearance as evidenced by reduced water spotting and the overall reduction of other deposits. Thus, the dish cleaning and/or dish rinsing compositions according to the present invention can be used as combined dish cleaning and rinsing product or can be used for the preparation of such combined products. Alternatively, the compositions as specified herein can be used as rinsing products or for the preparation of such rinsing products.

The compositions disclosed herein are thus suitable additives for standard dish cleaning and/or dish rinsing products that efficiently remove tough food residues while delivering high shine and/or anti-spotting benefits. Additionally, the compositions disclosed herein are suitable as dish cleaning and/or dish rinsing products as such.

The advantageous properties of the compositions according to the present invention are based on a synergistic effect between the surfactant-component (b) and the alkanediol-component and/or the boosting agent (a), meaning that the improved cleaning and/or drying performance, in particular in view of the significantly reduced spotting after drying, is a result of the specific combination of ingredients and is higher than the mere sum of the technical effects of the individual ingredients.

The present invention is specified in the appended claims. The invention itself, and its preferred variants, other objects and advantages, are however also apparent from the following detailed description in conjunction with the accompanying examples.

All percentages are by weight unless otherwise indicated.

Numeric ranges recited within the specification and given in the form “x to y” include the values defining the range and include each integer within the defined range. When multiple preferred numeric ranges are specified in this format, all ranges created by combining the various endpoints are also included.

In the context of the present invention, the term “at least one . . . ” or “one or more . . . ” means that the dish cleaning and/or dish rinsing composition according to the present invention can comprise either one or a mixture of two, three, four, five, six or even more different of the respective components following said term.

The term “and/or” expresses that a linkage exists, or an alternative is provided.

In the context of the present invention, the term “comprising” means that the named components are essential, but other components may be added and is still embraced by the present invention.

The term “consisting of” as used according to the present invention means that the total amount of components (a) to (c) adds up to 100% by weight, based on the total weight of the dish cleaning and/or rinsing composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

The term “optionally” means that the subsequently described compound/component may but need not to be present in the composition, and that the description includes variants, where the compound/component is included or variants, where the compound/component is absent.

The term “boosting” in the context of the present invention means “improving”, “enhancing”, “increasing”. Correspondingly, a “boosting agent” is an agent capable of “improving”, “enhancing”, “increasing” certain features or properties as defined herein, and in particular the anti-spotting effect, and thus, the rinsing and thereby also the dying properties of the composition. However, the term “boosting” is not restricted to the drying and rinsing boosting properties of the corresponding composition but also refers to the improved cleaning properties.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

### DETAILED DESCRIPTION OF THE INVENTION

Hereinafter, the present invention is described in more detail.

In one aspect, the present invention relates to a dish cleaning and rinsing composition comprising or consisting of:
(a1) 1,2-heptanediol;
(b1) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c1) optionally at least one enzyme or an enzyme formulation, comprising at least one enzyme.

Alternatively, the present invention relates in one aspect to a dish cleaning and rinsing composition comprising or consisting of:
(a2) 2,3-heptanediol;
(b2) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c2) optionally at least one enzyme or an enzyme formulation, comprising at least one enzyme.

In a further alternative, the present invention relates in one aspect to a dish cleaning and rinsing composition comprising or consisting of:
(a3) a mixture comprising 1,2-heptanediol and 2,3-heptanediol;
(b3) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c3) optionally at least one enzyme or an enzyme formulation, comprising at least one enzyme.

In another aspect, the present invention relates to a dish rinsing composition comprising or consisting of:
(a1) 1,2-heptanediol; and
(b1) at least one surfactant;
or
(a2) 2,3-heptanediol; and
(b2) at least one surfactant;
or
(a3) a mixture comprising 1,2-heptanediol and 2,3-heptanediol; and
(b3) at least one surfactant.

The pure rinsing compositions are not restricted to the surfactants specified for the dish cleaning and rinsing compositions (combined multiphase compositions). Any surfactant as specified herein is suitable for the dish rinsing composition. Nevertheless, according to a preferred variant also the in the dish rinsing compositions the surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols, i.e. the same surfactants as specified for the dish cleaning and rinsing compositions are also suitable for the pure dish rinsing compositions.

Consequently, the dish cleaning and rinsing compositions as specified herein can also be used as dish rinsing compositions. Accordingly, the following specification applies to both, the dish cleaning and rinsing compositions (combined multiphase compositions) as well as the dish rinsing compositions (rinse aids). Therefore, in the following the term “dish cleaning and/or rinsing composition” will be used unless the context explicitly dictates otherwise, in particular when reference is made to the rinsing, drying and anti-spotting properties. Beside these advantageous properties, the dish cleaning and rinsing formulations additionally provide for an improved cleaning performance.

The dish cleaning and/or dish rinsing compositions of the present invention are preferably used for reducing deposits and for reducing water spotting on dishes and/or as anti-spotting agents/compositions, and preferably as anti-spotting agent combined dish cleaning and rinsing products or as rinse aids.

The present composition provides for both, improved cleaning (reduction and/or removal of grease, dirt and other food deposits) and finishing benefits such as improved rinsing and drying properties, better shine and reduced spotting.

According to a further aspect of the present invention a dish cleaning and rinsing composition is disclosed which comprises or consists of:
(a) at least one boosting agent selected from the group consisting of:
   (a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (a^{II}) glyceryl caprylate;
   (a^{III}) 4-hydroxyacetophenone;
   (a^{IV}) ethyl hexyl glycerin;
   (a^{V}) tropolone; and
   any mixtures thereof;
(b) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols; and
(c) optionally at least one enzyme or an enzyme formulation, comprising at least one enzyme.

According to another further aspect of the present invention a dish rinsing composition is disclosed which comprises or consists of:
(a) at least one boosting agent selected from the group consisting of:
   (a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (a^{II}) glyceryl caprylate;
   (a^{III}) 4-hydroxyacetophenone;
   (a^{IV}) ethyl hexyl glycerin;
   (a^{V}) tropolone; and
   any mixtures thereof;
(b) at least one surfactant.

The pure rinsing compositions are not restricted to the surfactants specified for the dish cleaning and rinsing compositions (combined multiphase compositions). Any surfactant as specified herein is suitable for the dish rinsing composition. Nevertheless, according to a preferred variant also the in the dish rinsing compositions the surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols, i.e. the same surfactants as specified for the dish cleaning and rinsing compositions are also suitable for the pure dish rinsing compositions.

The dish cleaning and/or dish rinsing compositions of the present invention comprising at least one boosting agent (a^{I}) to (a^{V}) are preferably used for reducing deposits and/or for reducing water spotting on dishes and/or as anti-spotting agents.

In a preferred variant, the present invention relates to a dish cleaning and/or dish rinsing composition as specified above, wherein the at least one boosting agent (a^{I}) is a mixture comprising at least one first linear alkanediol having a carbon chain of 5 to 14 carbon atoms and one or more second linear alkanediol having a carbon chain of 5 to 14 carbon atoms, wherein the number of the carbon atoms of the first and the second alkanediol is either same or different.

Within the scope of the present invention the terms “cleaning” and “washing” are used synonymously and refer to the reduction and/or removal of deposits, i.e. the removal of undesired compounds from items to be cleaned, such as on tableware/dishes and other kitchen utensils such as cutlery/silverware, pots, pans, bakeware, and the like. These deposits might be caused by food soils remaining on the surfaces or stains caused by beverages such as red wine, coffee or tea, germs, and other contaminants.

The term “dish” or “dish ware” as used herein is intended to mean any form of kitchen utensil, dinner set or tableware, such as but not limited to pots, cutlery, pans, plates, cops, knives, forks, spoons, glassware such as glasses, cutting boards, porcelain etc.

Deposits are thus any form of unwanted residues of impureness, of dirt, food, grease etc. Sometimes also grit is formed during the dishwashing process due to redeposition of soils lifted during the washing process at high temperatures.

However, besides an improved cleanliness also a spotless and film-free and shiny appearance is expected.

The term “rinsing” as used herein refers to the post-wash treatment of the washed items and typically involves the application of a rinse agent or rinse aid to improve the drainage of water from the surfaces and thus to improve the drying performance. Rinse aids are also used to prevent the formation of visible spotting on surfaces of the washed items which is caused during the drying process by the evaporation of water droplets leaving behind dissolved limescale minerals. Within the context of the present invention the term “spotting” is understood to mean the formation of droplet residues, which can also be seen after the dishes have dried, especially on glasses or plastics. The spots correspond to water traces left after the water evaporation, the phenomenon is known under the term of spotting. The effects related to improved rinsing, improved drying and improved reduction of water-spotting are thus interrelated effects.

Spotting is further intensified when using carbonate and phosphate salts which are usual detergent ingredients.

In contrast to spotting where discrete mineral residues are formed on the surfaces, water deposits formed over a large, continuous portion of the respective surface are referred to as “filming”. Thus, the film corresponds to a uniform deposition all over the glassware surface, especially the film may result from the formation of a mineral precipitate, the phenomenon is known under the term of filming.

The term “dish cleaning and/or rinsing composition” as contemplated herein, refers to compositions that find use in the cleaning of undesired compounds from items to be cleaned, such as dishes and/or in the post-wash treatment for improving the rinsing and thus the drying performance. Dish cleaning compositions are also referred to as dish detergents or dishwasher detergents.

Surprisingly it has been observed that the compositions according to the present invention show the capability of simultaneously improving the cleaning properties and simultaneously improving the rinsing and/or drying performance allowing for better shine and a significant reduction of water spotting and/or filming. Since the inventive dish cleaning and rinsing compositions provide for improvements both in the washing step as well the rinsing step and thus also the drying step, the inventive dish cleaning and rinsing compositions according to the present invention allow for the provision of efficient combined products, i.e. so-called multi-phase or all-in-one products. Thus, based on said combined effect no further additives such as rinsing aids have to be added to the product formulations. The compositions disclosed herein as such additionally act as efficient drying and/or rinsing aids. This effect is particularly based on the inventive and synergistic combination of specific surfactants and a specific type of boosting agents, such as alkanediols, glyceryl caprylate, 4-hydroxyacetophenone, ethyl hexyl glycerin or tropolone.

However, also the dish rinsing compositions as specified herein (not restricted to specific surfactants) show the capability of improving the rinsing and/or drying performance allowing for better shine and a significant reduction of water spotting and/or filming. Accordingly, these formulations are highly suitable for use as rinse aids. No complex formulations are required in order to achieve the desired effects. This effect is particularly based on the inventive and synergistic combination of surfactants and a specific type of boosting agents, such as alkanediols, glyceryl caprylate, 4-hydroxyacetophenone, ethyl hexyl glycerin or tropolone.

Based on said combined effect no further additives such as rinsing aids have to be added to the product formulations. The compositions disclosed herein as such act as efficient drying and/or rinsing aids. Alternatively, the composition as disclosed herein can be used as rinsing agent and more specifically as anti-spotting agent. Thereby, the overall amount of surfactants and other ingredients can be reduced to at least achieve a similar cleaning and/or rinsing effect with considerably reduced water spotting and filming.

Therefore, preferably, the dish cleaning and/or dish rinsing compositions according to the present invention are used for the preparation of dish cleaning and/or dish rinsing products, preferably automatic dishwasher formulations with effective anti-scaling and anti-spotting properties. Additionally, it was found that the formulations disclosed herein allow for a gentle treatment, without damaging the items to be washed.

Alternatively, the dish cleaning and/or dish rinsing compositions according to the present invention are used as dish cleaning and/or dish rinsing products as such, and preferably combined dish cleaning and rinsing products or rinse aids.

The following specification on the single components (a), (b) and (c) is valid for both, the combined dish cleaning and rinsing compositions according to the present invention as well as the pure dish rinsing compositions according to the present invention. Accordingly, in the following the term “dish cleaning and/or rinsing composition” is used unless the context explicitly dictates otherwise.

Boosting Agent/Component (a), (a1), (a2), (a3)

The dish cleaning and/or rinsing compositions according to the present invention comprise at least one boosting agent as component (a), (a1), (a2) or (a3) that provide improved cleaning and/or rinse/drying performances to the dish cleaning and/or dish rinsing compositions.

Substances of component (a), (a1), (a2) or (a3) were found to efficiently enhance (“boost”) the cleaning and especially the rinsing properties of dish cleaning and/or rinsing formulations. Thereby not only improved cleanliness is achieved but also a considerable reduction in water-spotting and/or filming resulting in a clean and shiny appearance along with an improved drying effect which is particularly pronounced for plastic-based items.

Boosting agents (a) within the meaning of the present invention are:
(a^{I}) at least one linear alkanediols having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol; and preferably:
   (a1) 1,2-heptanediol;
   (a2) 2,3-heptanediol;
   (a3) a mixture comprising 1,2-heptanediol and 2,3-heptanediol;
(a^{II}) glyceryl caprylate;
(a^{III}) 4-hydroxyacetophenone;
(a^{IV}) ethyl hexyl glycerin;
(a^{V}) tropolone; and
any mixtures thereof.

Substances of component (a), (a1), (a2) and (a3) as specified above were found to efficiently boost the cleaning efficacy and/or the rinsing properties in a dish cleaning and/or dish rinsing composition, and in particular the rinsing properties. In this way, the overall cleaning performance and rinsing as well as drying properties are improved. It was surprisingly found that the substances according to component (a) are efficient in improving the reduction of deposits and/or water spotting on dishes.

Alkanediols (a1), (a2), (a3), (a^{I}):

The component (a) (alkanediol component) in the dish cleaning and/or rinsing composition according to the present invention is either 1,2-heptanediol (a1) or 2,3-heptanediol (a2), or a mixture comprising both heptanediols, i.e. 1,2-heptanediol plus 2,3-heptanediol (a3).

1,2-Heptanediol belongs to the category of alkanediols and is a straight chain alkanediol with the general formula:

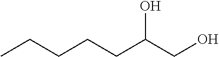

It has a carbon chain with 7 carbon atoms and the two functional OH groups of the alkanediol are in alpha,beta position and chemically bonded to the C1 and C2 carbon atoms in the alkanediol chain.

2,3-Heptanediol likewise belongs to the category of alkanediols and is a straight chain alkanediol with the general formula:

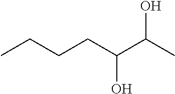

It has a carbon chain with 7 carbon atoms and the two functional OH groups of the alkanediol are in beta,gamma position and chemically bonded to the C2 and C3 carbon atoms in the alkanediol chain.

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, alkanediols such as 1,2-pentanediol, 1,2-hexanediol and 1,2-heptanediol are soluble both in water and oils. In contrast, 1,2-octanediol is a solid and tends to precipitate or recrystallize in oily solutions as well as in water at 0.5%. On the other hand, 1,2-decanediol is a solid and soluble only in oils. Apart from moisturizing, some 1,2-alkanediols are used as viscosity modifiers.

The boosting component (a) in the dish cleaning and/or rinsing composition according to the present invention is selected from the group consisting of:
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(a^{II}) glyceryl caprylate;
(a^{III}) 4-hydroxyacetophenone;
(a^{IV}) ethyl hexyl glycerin;
(a^{V}) tropolone; and
any mixture thereof.

The boosting agent (a) of the dish cleaning and/or rinsing composition according to the present invention is in a first alternative at least one linear alkanediol having a carbon chain of 5 to 14 carbon atoms.

Moreover, in a second alternative of this aspect, the boosting component (a) may include or consist of at least one first linear alkanediol in combination with one or more second linear alkanediol, preferably at least one first linear alkanediol having a carbon chain of 5 to 14 carbon atoms and at least one second linear alkanediol having a carbon chain of 5 to 14 carbon atoms. Therefore, the invention also entails a mixture comprising a first and a second alkanediol as described herein.

Since the at least one first linear alkanediol of the invention can be selected from the same lists and types of compounds as the at least one linear alkanediol according to the first alternative of this aspect, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 14 carbon atoms or can comprise one first linear alkanediol having a carbon chain of 5 to 14 carbon atoms or can comprise more than one linear alkanediol or more than one first linear alkanediol having a carbon chain of 5 to 14 carbon atoms, i.e. two, three, four or more different linear alkanediols or first linear alkanediols having a carbon chain of 5 to 14 carbon atoms.

The at least one linear alkanediol or the at least one first linear alkanediol according to the present invention consists of a chain of 5 to 14 carbon atoms joined to each other by single covalent bonds with two OH functional groups attached to two different carbon atoms in the chain.

The at least one linear alkanediol or the at least one first linear alkanediol having a carbon chain of 5 to 14 carbon atoms in the dish cleaning and/or rinsing composition according to the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one linear alkanediol or the at least one first linear alkanediol has a carbon chain of 5 to 13 carbon atoms and is selected from the group consisting of pentanediol, hexanediol, heptanediol, octanediol, nonanediol, decanediol, undecanediol, dodecanediol and tridecanediol.

In a more preferred variant, the at least one linear alkanediol or the at least one first linear alkanediol has a carbon chain of 5 to 10 carbon atoms and is selected from the group consisting of pentanediol, hexanediol, heptanediol, octanediol, nonanediol, and decanediol.

In an alternatively preferred variant, the at least one linear alkanediol or the at least one first linear alkanediol has a carbon chain of 10 to 14 carbon atoms and is selected from the group consisting of decanediol, undecanediol, dodecanediol, tridecanediol, and tetradecanediol, and preferably the at least one first linear alkanediol has a carbon chain of 10 to 13 carbon atoms.

In a more preferred variant, the at least one linear alkanediol or the at least one first linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a still more preferred variant, the at least one linear alkanediol or the at least one first linear alkanediol is selected from the group consisting of alkanediols having a higher number of carbon atoms of 9 to 14, i.e. nonanediol, decanediol, undecanediol, dodecanediol, tridecanediol, tetradecanediol and any mixture thereof, or is selected from the group consisting of alkanediols having a number of carbon atoms of 9 to 13, i.e. nonanediol, decanediol, undecanediol, dodecanediol, tridecanediol, and any mixture thereof, or is selected from the group consisting of alkanediols having a number of carbon atoms of 9 to 12, i.e. nonanediol, decanediol, undecanediol, dodecanediol, and any mixture thereof, or is selected from the group consisting of alkanediols having a number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either pentanediol, hexanediol, heptanediol or octanediol, or any mixture thereof.

In a still more preferred variant, the at least one linear alkanediol or the at least one first linear alkanediol is either nonanediol, decanediol, undecanediol or dodecanediol, or any mixture thereof.

In a most preferred variant, the at least one linear alkanediol or the at least first linear alkanediol is heptanediol.

In a second alternative, the dish cleaning and/or rinsing composition according to the present invention comprises as boosting agent a mixture comprising or consisting of at least one first linear alkanediol having a carbon chain of 5 to 14 carbon atoms and one or more second linear alkanediol(s) having a carbon chain of 5 to 14 carbon atoms which is/are different from the first linear alkanediol.

This means that the boosting agent is an alkanediol mixture comprising at least one first linear alkanediol having a carbon chain of 5 to 14 carbon atoms and one or more, i.e. two, three, four or more second linear alkanediols having a carbon chain of 5 to 14 carbon atoms.

In this alternative, the first linear alkanediol can be any of the alkanediols as described herein for the linear alkanediol in general and in particular for the first alternative of the invention.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The phrase “different from each other means” that the first linear alkanediols and the second linear alkanediols in the mixture are different either with regard to the length of their carbon chain, i.e. number of the carbon atoms, or with regard to their constitutional isomerism.

Likewise, the number of the carbon atoms of the first linear alkanediols and the second linear alkanediols in the mixture can also be the same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative of the invention.

The second linear alkanediol preferably consists of a chain of 5 to 14 carbon atoms joined to each other by single covalent bonds with two OH functional groups attached to two different carbon atoms in the chain.

The at least one second linear alkanediol having a carbon chain of 5 to 14 carbon atoms in the dish cleaning and/or rinsing composition according to the present invention is selected from the group consisting of pentanediol, hexanediol, heptanediol, octanediol, nonanediol, decanediol, undecanediol, dodecanediol, tridecanediol and tetradecanediol.

In a preferred variant, the at least one second linear alkanediol has a carbon chain of 5 to 13 carbon atoms and is selected from the group consisting of pentanediol, hexanediol, heptanediol, octanediol, nonanediol, decanediol, undecanediol, dodecanediol and tridecanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol.

In a more preferred variant, the at least one second linear alkanediol is selected from the group consisting of pentanediol, hexanediol, heptanediol, octanediol and nonanediol, most preferably heptanediol, octanediol and nonanediol.

In a preferred variant the present invention thus relates to a dish cleaning and/or dish rinsing composition, wherein the at least one linear alkanediol or the at least one first linear alkanediol is selected from the group consisting of pentanediol, hexanediol, heptanediol, octanediol, nonanediol, decanediol, undecanediol, dodecanediol, tridecanediol, and tetradecanediol, and any mixture thereof; and/or wherein the second linear alkanediol is selected from the group consisting of pentanediol, hexanediol, heptanediol, octanediol, nonanediol, decanediol, undecanediol, dodecanediol, tridecanediol, and tetradecanediol, and any mixture thereof.

If both the first and the second alkanediol is for example heptanediol, then the second linear alkanediol heptanediol is a different constitutional isomer or stereoisomer from the first linear alkanediol according to the second alternative.

In a preferred variant, the dish cleaning and/or rinsing composition according to the present invention comprises a mixture comprising at least one first linear alkanediol having a carbon chain of 5 to 14 carbon atoms and one or more second linear alkanediol having a carbon chain of 5 to 14 carbon atoms, wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or in regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms. However, beyond that, the first linear alkanediol and the second linear alkanediol can be different in regard to their constitutional isomerism or with regard to their stereoisomerism.

In a preferred variant the present invention relates to a dish cleaning and/or dish rinsing composition, wherein the at least one linear alkanediol or the at least one first linear alkanediol is selected from the group consisting of pentanediol, hexanediol, heptanediol, octanediol, nonanediol, decanediol, undecanediol, dodecanediol, tridecanediol, and tetradecanediol; and/or the one or more second linear alkanediol is selected from the group consisting of pentanediol, hexanediol, heptanediol, octanediol, nonanediol, decanediol, undecanediol, dodecanediol, tridecanediol, and tetradecanediol.

Particular preferred is a boosting agent mixture, wherein the at least one first linear alkanediol is selected from an alkanediol having a lower number of carbon atoms from 5 to 8 and wherein the one or more second alkanediol is selected from an alkanediol having a higher number of carbon atoms from 9 to 14, preferably from 9 to 13.

Most preferred is a boosting agent mixture, wherein the at least one first linear alkanediol is selected from the group consisting of pentanediol, hexanediol, heptanediol, octanediol, and any mixture thereof, and the one or more second alkanediol is selected from the group consisting of nonanediol, decanediol, undecanediol, dodecanediol, tridecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only on the position of a functional group on a parent structure, which in this case, in particular, is the position of the two alcohol functions.

Depending on the number of the carbon atoms of the carbon chain of the alkanediol, there are various position isomers of the alkanediol: (x,x+1) constitutional isomers; (x,x+2) constitutional isomers; (x,x+3) constitutional isomers; etc. and alpha,omega constitutional isomers when the alcohol functions are at the terminal ends of the carbon chain, wherein x stands for the number of the carbon atom in the alkanediol chain, to which the OH groups of the alkanediol are chemically bonded. For example: if x is 1, the two OH groups of the alkanediol are chemically bonded to the C1 and C2 carbon atoms in the alkanediol chain; if x is 2, the two OH groups of the alkanediol are chemically bonded to the C2 and C3 carbon atoms in the alkanediol chain, etc.

In the (x,x+1) constitutional isomers, the two OH functional groups are vicinally attached to two different adjacent carbon atoms in the chain. In the (x,x+2) constitutional isomers, the two OH functional groups are attached to two different carbon atoms in the chain where the two carbon atoms are separated by one carbon atom. In the (x,x+3) constitutional isomers, the two OH functional groups are attached to two different carbon atoms in the chain where the two carbon atoms are separated by two carbon atoms. In the alpha,omega constitutional isomers, the two functional groups are attached to the first carbon atom and to the terminal carbon atom.

In a preferred variant of the dish cleaning and/or rinsing composition according to the present invention, the at least one linear alkanediol having a carbon chain of 5 to 14 carbon atoms, is preferably a vicinal (x,x+1)-diol, selected from the group consisting of a 1,2-diol, 2,3-diol, 3,4-diol, 4,5-diol, further (x,x+1)-diols, and mixtures thereof, preferably an alpha,beta-1,2-constitutional isomer.

In a preferred variant of the dish cleaning and/or rinsing composition according to the present invention, the at least one first linear alkanediol and/or the one or more second linear alkanediol having a carbon chain of 5 to 14 carbon atoms is a vicinal (x,x+1)-diol, selected from the group consisting of a 1,2-diol, 2,3-diol, 3,4-diol, 4,5-diol, further (x,x+1)-diols, and mixtures thereof, preferably an alpha,beta-1,2-constitutional isomer.

Thus, according to a preferred embodiment of the dish cleaning and/or dish rinsing composition according to the invention, the at least one linear alkanediol, the at least one first linear alkanediol and/or the one or more second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol, and further preferred a 1,2-alkanediol.

According to the present invention, vicinal (x,x+1)-diols are most preferred, such as alpha,beta or beta,gamma or gamma,delta etc.

In a still preferred variant of the dish cleaning and/or rinsing composition according to the present invention, the linear alkanediol and in particular the at least one first linear alkanediol and/or the one or more second linear alkanediol, is a 1,2-alkanediol, a 2,3-alkanediol, a 3,4-alkanediol, or mixtures thereof, more preferred a 2,3-alkanediol.

The 1,2-alkanediols of the linear alkanediol, in particular the at least one first linear alkanediol having a carbon chain of 5 to 14 carbon atoms and/or one or more the second linear alkanediol having a carbon chain of 5 to 14 carbon atoms, can preferably be those as represented by the following formulae:

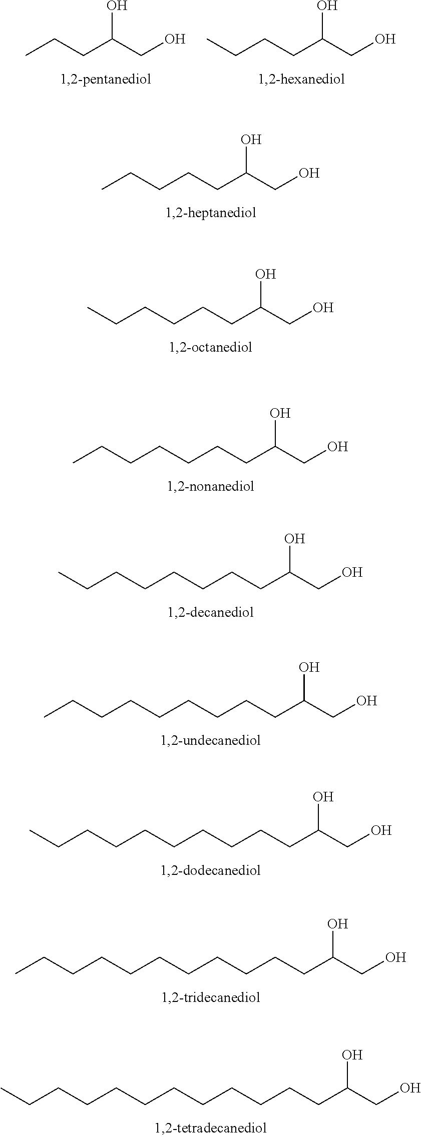

According to a preferred embodiment, a dish cleaning and/or dish rinsing composition is disclosed, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

The 2,3-alkanediols of the linear alkanediol of the invention, in particular the at least one first linear alkanediol having a carbon chain of 5 to 14 carbon atoms and/or the one or more second linear alkanediol having a carbon chain of 5 to 14 carbon atoms, can preferably be those as represented by the following formulae:

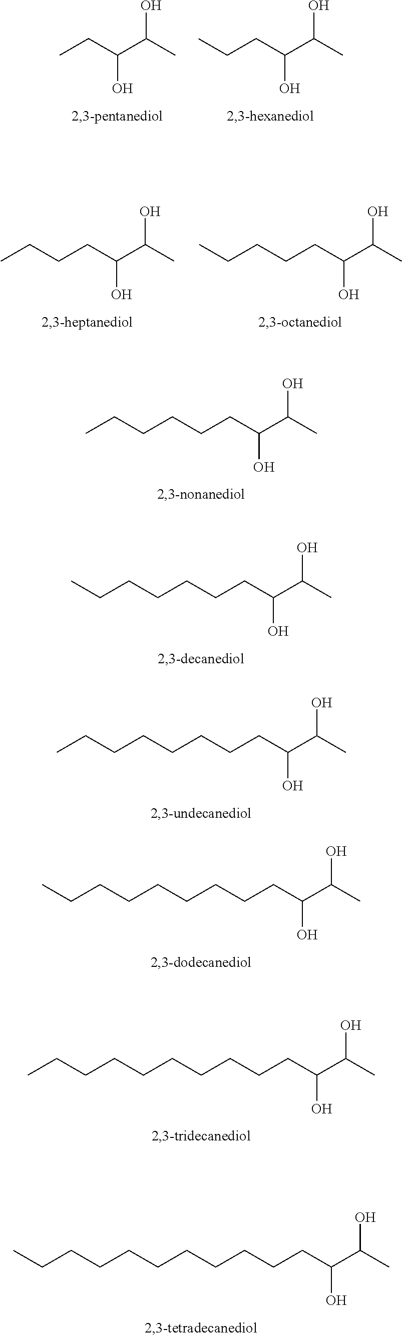

Alternatively, preferably, in the dish cleaning and/or dish rinsing composition according to the present invention, the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof.

The 3,4-alkanediols of the linear alkanediol, preferably the at least one first linear alkanediol having a carbon chain of 5 to 14 carbon atoms and/or the one or more second linear alkanediol having a carbon chain of 5 to 14 carbon atoms, can preferably be those as represented by the following formulae:

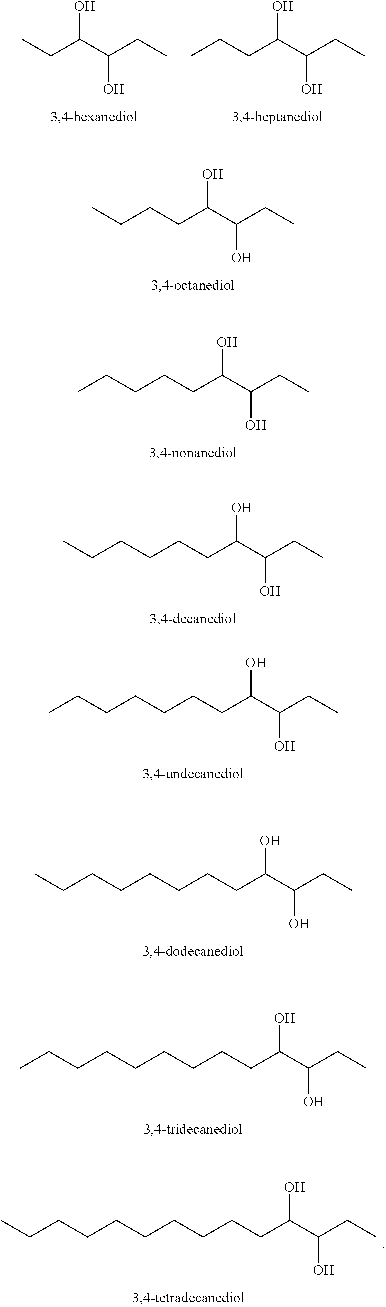

In a preferred variant of the dish cleaning and/or rinsing composition according to the present invention, the at least one linear alkanediol or the at least one first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
and any mixture thereof.

According to a preferred variant, in the dish cleaning and/or dish rinsing composition according to the present invention the at least one linear alkanediol or the at least one first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

Of the aforesaid linear alkanediols or the first linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90% to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol or mixtures of said liquid alkanediols are particularly preferred.

In a further preferred variant of the dish cleaning and/or rinsing composition according to the present invention, the linear alkanediol or the first linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol,
and any mixture thereof.

More preferred, in the dish cleaning and/or rinsing composition according to the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the dish cleaning and/or rinsing composition according to the present invention, the linear alkanediol or the first linear alkanediol is an alpha,beta or a beta,gamma diol as either 1,2-heptanediol or 2,3-heptanediol or a mixture thereof. However, the linear alkanediol or the first linear alkanediol can also preferably be an alpha,beta or a beta,gamma diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 1,2-pentanediol or 2,3-pentanediol or 1,2-hexanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the dish cleaning and/or rinsing composition according to the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the dish cleaning and/or rinsing composition according to the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol, or any mixture thereof.

In a most preferred variant, the at least one linear alkanediol or the at least first linear alkanediol is 1,2-heptanediol.

It was found that these substances show particularly pronounced anti-spotting properties and are suitable boosting agents within the meaning of the present invention. 1,2-Alkanediols having a lower number of carbon atoms are thus efficient for use as anti-spotting agents in dish cleaning and/or rinsing compositions. The improved anti-spotting properties in the dish cleaning and/or rinsing compositions results in a better rinsing and drying performance.

In a still more preferred variant, the at least one linear alkanediol or the at least one first linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-nonanediol or 1,2-decanediol or 1,2-undecanediol or 1,2-dodecanediol, or any mixture thereof.

According to a preferred variant, the at least one linear alkanediol or the at least one first linear alkanediol is selected from the group consisting of 1,2-alkanediols having a higher number of carbon atoms, and more specifically of more than 10 carbon atoms, i.e. 11, 12, 13, or 14 carbon atoms, i.e. 1,2-undecanediol, 1,2-dodecanediol, 1,2-tridecanediol, or 1,2-tetradecanediol.

It was found that these substances having a higher number of carbon atoms, and more specifically more than 10 carbon atoms, show better film-forming properties and thereby reduce the occurrence of spotting efficiently due to a more uniform drying resulting in high shine and overall improved finishing properties. 1,2-Alkanediols having a higher number of carbon atoms, and more specifically of more than 10 carbon atoms are thus efficient for use in, or as anti-spotting agents.

Additionally, it was found that 1,2-alkanediols having a higher number of carbon atoms, and more specifically of more than 10 carbon atoms, show improved cleaning properties and efficiently prevent the redeposition of soil thus reducing the formation of deposits on the washed items.

In an alternatively preferred variant, the at least one linear alkanediol or the at least one first linear alkanediol is either 1,2-nonanediol, 1,2-decanediol, 1,2-undecanediol or 1,2-dodecanediol, or any mixture thereof.

In a still more preferred variant, the at least one linear alkanediol or the at least one first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 2,3-pentanediol, 2,3-hexanediol, 2,3-heptanediol or 2,3-octanediol or any mixture thereof.

In a most preferred variant, the at least one linear alkanediol or the at least first linear alkanediol is 2,3-heptanediol.

It was found that these substances show particularly pronounced anti-spotting properties. 2,3-Alkanediols having a lower number of carbon atoms are thus efficient for use as anti-spotting agents in dish cleaning and/or rinsing compositions. The improved anti-spotting properties in the dish cleaning and/or rinsing compositions results in a better rinsing and drying performance.

In a still more preferred variant, the at least one linear alkanediol or the at least one first linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tetradecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

Surprisingly it was found that longer-chain alkanediols contribute to an improved cleaning along with a more homogeneous film formation (“filming”) of water during the washing and rinsing process, thereby allowing for improved drying performance (more homogenous drying) with considerably reduced spotting. Also a combination of shorter and longer alkanediols results in an improvement of the rinsing and drying performances.

In a still more preferred variant, the at least one linear alkanediol or the at least one first linear alkanediol is either 2,3-nonanediol, 2,3-decanediol, 2,3-undecanediol or 2,3-dodecanediol, or any mixture thereof.

According to a preferred variant, the at least one linear alkanediol or the at least one first linear alkanediol is selected from the group consisting of 2,3-alkanediols having a higher number of carbon atoms, and more specifically of more than 10 carbon atoms, i.e. 11, 12, 13 or 14 carbon atoms, i.e. 2,3-undecanediol, 2,3-dodecanediol, 2,3-tridecanediol or 2,3-tetradecanediol.

It was found that these substances having a higher number of carbon atoms, and more specifically more than 10 carbon atoms show better cleaning and film-forming properties and thereby reduce the occurrence of spotting efficiently due to a more uniform drying resulting in high shine and overall improved finishing properties. 2,3-Alkanediols having a higher number of carbon atoms, and more specifically of more than 10 carbon atoms are thus efficient for use in, or as anti-spotting agents.

Additionally, it was found that 2,3-alkanediols having a higher number of carbon atoms, and more specifically of more than 10 carbon atoms, show improved cleaning properties and efficiently prevent the redeposition of soil thus reducing the formation of deposits on the washed items.

In a preferred variant of the dish cleaning and/or dish rinsing composition according to the present invention, the one or more second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
and any mixture thereof.

According to a preferred variant, in the dish cleaning and/or dish rinsing composition according to the present invention the one or more second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

Of the aforesaid second linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90% to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol or mixtures of said liquid alkanediols are particularly preferred.

In a more preferred variant of the dish cleaning and/or rinsing composition according to the present invention, the second linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol, and any mixture thereof.

More preferred, in the dish cleaning and/or rinsing composition according to the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the dish cleaning and/or rinsing composition according to the present invention, the second linear alkanediol is an alpha,beta or a beta,gamma diol as either 1,2-pentanediol or 2,3-pentanediol or a mixture thereof. However, the second linear alkanediol can also preferably be an alpha,beta or a beta,gamma diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 1,2-pentanediol or 2,3-pentanediol or 1,2-hexanediol or 2,3-hexanediol or 1,2-heptanediol or 2,3-heptanediol, or 2,3-octanediol or 2,3-nonanediol.

Likewise, in a further preferred variant of the dish cleaning and/or rinsing composition according to the present invention, the second linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the dish cleaning and/or rinsing composition according to the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the one or more second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol or any mixture thereof.

In a most preferred variant, the second linear alkanediol is 1,2-heptanediol.

It was found that these substances show particularly pronounced anti-spotting properties. 1,2-Alkanediols having a lower number of carbon atoms are thus efficient for use as anti-spotting agents in dish cleaning and/or rinsing compositions. The improved anti-spotting properties in the dish cleaning and/or rinsing compositions results in a better rinsing and drying performance.

In a still more preferred variant, the one or more second linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-nonanediol, 1,2-decanediol, 1,2-undecanediol or 1,2-dodecanediol, or any mixture thereof.

According to a preferred variant the second linear alkanediol is selected from the group consisting of 1,2-alkanediols having a higher number of carbon atoms, and more specifically of more than 10 carbon atoms, i.e. 11, 12, 13 or 14 carbon atoms, i.e. 1,2-undecanediol, 1,2-dodecanediol, 1,2-tridecanediol or 1,2-tetradecanediol.

It was found that these substances (1,2-alkanediols) having a higher number of carbon atoms, and more specifically more than 10 carbon atoms show better film-forming properties and thereby reduce the occurrence of spotting efficiently due to a more uniform drying resulting in high shine and overall improved finishing properties and additionally show improved cleaning properties and efficiently prevent the redeposition of soil thus reducing the formation of deposits on the washed items.

In a still more preferred variant, the one or more second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol, or any mixture thereof.

In a most preferred variant, the second linear alkanediol is 2,3-heptanediol.

It was found that these substances show particularly pronounced anti-spotting properties. 2,3-Alkanediols having a lower number of carbon atoms are thus efficient for use as anti-spotting agents in dish cleaning and/or rinsing compositions. The improved anti-spotting properties in the dish cleaning and/or rinsing compositions results in a better rinsing and drying performance.

In a still more preferred variant, the one or more second linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2,3-nonanediol, 2,3-decanediol, 2,3-undecanediol, 2,3-dodecanediol, 2,3-tridecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-nonanediol, 2,3-decanediol, 2,3-undecanediol, or 2,3-dodecanediol, or any mixture thereof.

According to a preferred variant the second linear alkanediol is selected from the group consisting of 2,3-alkanediols having a higher number of carbon atoms, and more specifically of more than 10 carbon atoms, i.e. 2,3-undecanediol, 2,3-dodecanediol, 2,3-tridecanediol or 2,3-tetradecanediol.

It was found that these substances having a higher number of carbon atoms, and more specifically more than 10 carbon atoms show better film-forming properties and thereby reduce the occurrence of spotting efficiently due to a more uniform drying resulting in high shine and overall improved finishing properties and additionally show improved cleaning properties and efficiently prevent the redeposition of soil thus reducing the formation of deposits on the washed items.

Thus, according to a preferred variant, the second linear alkanediol is preferably selected from the group consisting of 2,3-alkanediols having a higher number of carbon atoms, and more specifically more than 10 carbon atoms, i.e. 11, 12, 13 or 14 carbon atoms. It was found that these substances show efficient boosting properties. 2,3-Alkanediols having a higher number of carbon atoms, and more specifically more than 10 carbon atoms are thus efficient for use boosting agents in dish cleaning and/or rinsing compositions resulting in improved cleaning and drying performances.

In a particular preferred variant, in the dish cleaning and/or rinsing composition according to the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a particularly preferred variant, the dish cleaning and/or rinsing composition according to the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol; or
a mixture comprising 1,2-dodecanediol and 2,3-dodecanediol; or
a mixture comprising 1,2-tridecanediol and 2,3-tridecanediol; or
a mixture comprising 1,2-tetradecanediol and 2,3-tetradecanediol.

In said homo alkanediol mixtures the first linear alkanediol and the second linear alkanediol have the same number of carbon atoms.

Particularly favorable is a mixture including 1,2-pentanediol in combination with 2,3-pentanediol or a mixture including 1,2-heptanediol in combination with 2,3-heptanediol, or a mixture including 1,2-octanediol in combination with 2,3-octanediol and/or 3,4-octanediol.

Due to their outstanding boosting effect a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred.

The above specified homo alkanediol mixtures according to the present invention, comprising a 1,2-alkanediol and a 2,3-alkanediol are characterized by a synergistically intensified action, i.e. the alkanediol mixtures boost the cleaning power and the rinsing/drying performance of a dish cleaning and/or rinsing composition in a synergistic way compared to their respective single 1,2-alkanediol or 2,3-alkanediol substances resulting in improved cleanness and efficient anti-spotting.

Said synergistic effect or action in boosting the cleaning power and the rinsing/drying performance is found for the homo mixture including 1,2-pentanediol and 2,3-pentanediol.

Said synergistic effect in boosting the cleaning power and the rinsing/drying performance is also observed for the homo mixture including 1,2-hexanediol and 2,3-hexanediol.

The homo mixture including 1,2-heptanediol and 2,3-heptanediol is particularly beneficial since it has a particular pronounced synergistic effect on the boosting of the cleaning power and the rinsing/drying performance of a dish cleaning and/or rinsing composition.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically boosting the cleaning power and the rinsing/drying performance of a dish cleaning and/or rinsing composition.

Also, the alkanediol mixture comprising 1,2-decanediol and 2,3-decanediol or the alkanediol mixture comprising 1,2-undecanediol and 2,3-undecanediol synergistically boost the cleaning power and the rinsing/drying performance of a dish cleaning and/or rinsing composition.

A synergistic boosting effect is also true for an alkanediol mixture including 1,2-dodecanediol and 2,3-dodecanediol or an alkanediol mixture including 1,2-tridecanediol and 2,3-tridecanediol.

The afore-mentioned synergistically boosting of the cleaning power and the rinsing/drying performance of a dish cleaning and/or rinsing composition is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol.

The afore specified homo alkanediol mixtures including a 1,2-alkanediol and the corresponding 2,3-alkanediol display a remarkably synergistic effect and are clearly superior to the individually corresponding 1,2-alkanediols or 2,3-alkanediols and having the same concentration.

In a particularly preferred variant, the dish cleaning and/or rinsing composition according to the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
1,2-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
1,2-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
1,2-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
1,2-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
1,2-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
1,2-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
1,2-pentanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-hexanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-heptanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-octanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-nonanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-decanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-undecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-tridecanediol in combination with one of 2,3-pentanediol, 2,3-hexanediol, 2,3-heptanediol, 2,3-octanediol, 2,3-nonanediol, 2,3-dodecanediol, 2,3-undecanediol, 2,3-dodecanediol, 2,3-tridecanediol, 2,3-tetradecanediol; or
1,2-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
2,3-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
2,3-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
2,3-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
2,3-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol; or 1,2-tetradecanediol; or
2,3-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol; or 1,2-tetradecanediol; or
2,3-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
2,3-pentanediol in combination with one of 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 1,2-tetradecanediol; or
2,3-hexanediol in combination with one of 2,3-pentanediol, 2,3-heptanediol, 2,3-octanediol, 2,3-nonanediol, 2,3-decanediol, 2,3-undecanediol, 2,3-dodecanediol, 2,3-tridecanediol, or 1,2-tetradecanediol; or
2,3-heptanediol in combination with one of 2,3-pentanediol, 2,3-hexanediol, 2,3-octanediol, 2,3-nonanediol, 2,3-decanediol, 2,3-undecanediol, 2,3-dodecanediol, 2,3-tridecanediol, or 1,2-tetradecanediol; or
2,3-octanediol in combination with one of 2,3-pentanediol, 2,3-hexanediol, 2,3-heptanediol, 2,3-nonanediol, 2,3-decanediol, 2,3-undecanediol, 2,3-dodecanediol, 2,3-tridecanediol, or 1,2-tetradecanediol; or
2,3-nonanediol in combination with one of 2,3-pentanediol, 2,3-hexanediol, 2,3-heptanediol, 2,3-octanediol, 2,3-decanediol, 2,3-undecanediol, 2,3-dodecanediol, 2,3-tridecanediol, or 1,2-tetradecanediol; or
2,3-decanediol in combination with one of 2,3-pentanediol, 2,3-hexanediol, 2,3-heptanediol, 2,3-octanediol, 2,3-nonanediol, 2,3-undecanediol, 2,3-dodecanediol, 2,3-tridecanediol, or 1,2-tetradecanediol; or
2,3-undecanediol in combination with one of 2,3-pentanediol, 2,3-hexanediol, 2,3-heptanediol, 2,3-octanediol, 2,3-nonanediol, 2,3-decanediol, 2,3-dodecanediol, 2,3-tridecanediol, or 1,2-tetradecanediol; or
2,3-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-tridecanediol, or 1,2-tetradecanediol; or
2,3-tridecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, or 1,2-tetradecanediol; or
2,3-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol or 2,3-tridecanediol.

In a particular preferred variant, the dish cleaning and/or rinsing composition according to the present invention which comprises a mixture or a combination comprising at least one first linear alkanediol and one or more second linear alkanediol thus may include any of the following mixtures/combinations:
a mixture comprising 1,2-hexanediol and 1,2-octanediol; or
a mixture comprising 1,2-hexanediol and 2,3-octanediol; or
a mixture comprising 1,2-octanediol and 2,3-hexanediol; or
a mixture comprising 1,2-octanediol and 2,3-heptanediol; or
a mixture comprising 1,2-pentanediol and 2,3-hexanediol; or
a mixture comprising 1,2-pentanediol and 2,3-heptanediol; or
a mixture comprising 1,2-pentanediol and 2,3-octanediol; or
a mixture comprising 1,2-pentanediol and 1,2-nonanediol; or
a mixture comprising 1,2-pentanediol and 2,3-nonanediol; or
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 2,3-octanediol; or
a mixture comprising 1,2-heptanediol and 1,2-nonanediol; or
a mixture comprising 1,2-heptanediol and 2,3-nonanediol. or
a mixture comprising 1,2-heptanediol and 1,2-decanediol; or
a mixture comprising 1,2-heptanediol and 1,2-undecanediol; or
a mixture comprising 1,2-heptanediol and 1,2-dodecanediol; or
a mixture comprising 1,2-heptanediol and 1,2-tridecanediol; or
a mixture comprising 1,2-heptanediol and 1,2-tetradecanediol.

In said hetero alkanediol mixtures described above, the first linear alkanediol and the second linear alkanediol have a different number of carbon atoms.

In a particular preferred variant, the dish cleaning composition and/or rinsing composition according to the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, such alkanediol mixtures have a particularly pronounced boosting effect in terms of cleaning and rinsing/drying performance, in particular in view of the improved anti-spotting effect.

The above specified alkanediol mixtures according to the present invention, comprising at least one first linear alkanediol and at least one second linear alkanediol, are characterized by a synergistically intensified action, i.e. the alkanediol mixtures boost the cleaning power and/or the rinsing/drying performance in a dish cleaning and/or rinsing composition in a synergistic way compared to the corresponding individual 1,2-alkanediol or 2,3-alkanediol substances.

Still more preferred is a boosting agent mixture, wherein the at least one first linear alkanediol is selected from a 1,2-alkanediol having a lower number of carbon atoms from 5 to 8 and the one or more second alkanediol is selected from a 1,2-alkanediol having a higher number of carbon atoms from 9 to 14, preferably from 9 to 13.

Most preferred is a boosting agent mixture, wherein the at least one first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, 1,2-dodecanediol, 1,2-tridecanediol, 1,2-tetradecanediol, and any mixture thereof.

Most preferred is an boosting agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 13, i.e. 1,2-nonanediol, 1,2-decanediol, 1,2-undecanediol, 1,2-dodecanediol, 1,2-tridecanediol, and any mixture thereof.

Surprisingly, such hetero alkanediol mixtures of short chain alkanediols and long chain alkanediols have a particularly pronounced boosting effects and show improved anti-spotting properties.

More preferred are such alkanediol mixtures, wherein the difference between the number of carbon atoms of the at least one first linear alkanediol and the number of carbon atoms of the one or more second alkanediol is at least 2 carbon atoms. In those alkanediol mixtures, short-chain and long-chain alkanediols are combined with each other resulting in improved rinsing properties and/or anti-spotting properties along with improved cleaning properties.

Thus, according to a preferred embodiment in the boosting agent mixture, the difference between the number of carbon atoms of the at least one first linear alkanediol and the number of carbon atoms of the one or more second alkanediol is at least 2 carbon atoms. In those mixtures, short-chain and long-chain alkanediols are combined with each other resulting in a balance by using different lipophilic and hydrophilic properties of said alkanediols for the boosting of the cleaning and/or rinsing/drying performance.

Still more preferred is a boosting agent mixture, wherein the difference between the number of carbon atoms of the at least one first linear alkanediol and the number of carbon atoms of the one or more second alkanediol is at least 3 carbon atoms. In such a mixture, the boosting effect in view of the rinsing and/or anti-spotting properties is particularly pronounced.

This results in further enhanced cleaning and drying/rinsing performances.

Such combinations may include any of the following mixtures/combinations:
1,2-pentanediol in combination with one of 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-nonanediol, 1,2-decanediol, 1,2-undecanediol, 1,2-dodecanediol, 1,2-tridecanediol, 1,2-tetradecanediol; or
1,2-heptanediol in combination with one of 1,2-decanediol, 1,2-undecanediol, 1,2-dodecanediol, 1,2-tridecanediol, or 1,2-tetradecanediol and
1,2-octanediol in combination with one of 1,2-undecanediol, 1,2-dodecanediol, 1,2-tridecanediol, or 1,2-tetradecanediol.

In a preferred variant according to the present invention in the dish cleaning and/or rinsing composition the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and mixtures thereof, i.e. mixtures of two, three or more of the aforementioned substances.

In a more preferred variant of the dish cleaning and/or rinsing composition according to the present invention, the at least one linear alkanediol is selected from the group consisting of 2,3-pentanediol, 2,3-hexanediol, 2,3-heptanediol, 2,3-octanediol, 2,3-nonanediol, and mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, 2,3-dodecanediol, 2,3-tridecanediol, and 2,3-tetradecanediol to a dish cleaning and/or rinsing composition as specified herein results in a remarkable boosting of the cleaning efficiency and the anti-spotting properties, compared to the composition without the addition of an 2,3-alkanediol.

According to an alternatively preferred variant, the dish cleaning and/or rinsing composition according to the present invention comprises at least one boosting agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediols having a carbon chain of 5 to 8 carbon atoms, which is different from the first linear 1,2-alkanediol.

In a still more preferred variant, the dish cleaning and/or rinsing composition according to the present invention comprises at least one boosting agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediols having a carbon chain of 6 to 7 carbon atoms, which is different from the first linear 1,2-alkanediol.

Surprisingly, it was found that these short-chain 1,2-alkanediols are particularly suitable boosting agents and which can also efficiently be incorporated into dish cleaning and/or rinsing formulations and which show improved rinsing properties resulting in enhanced drying performances. It was found that these substances show better cleaning and especially rinsing properties with considerably reduced spotting. Such compositions show improved rinsing properties with considerably reduced spotting compared to compositions without the addition of such substances. Based thereon the substances and compositions disclosed herein are excellent rinsing agents and more specifically anti-spotting agents.

According to a particularly preferred variant, the dish cleaning and/or rinsing composition according to the present invention comprises at least one boosting agent selected from the group consisting of at least one linear 1,2-alkanediol having a carbon chain of 9 to 14 atoms, or a mixture comprising at least one first linear 1,2-alkanediol having a carbon chain of 9 to 14 carbon atoms and one or more second linear 1,2-alkanediols having a carbon chain of 9 to 14 carbon atoms, which is different from the first linear 1,2-alkanediol.

In a more preferred variant, the dish cleaning and/or rinsing composition according to the present invention comprises at least one boosting agent selected from the group consisting of at least one linear 1,2-alkanediol having a carbon chain of 10 to 13 atoms, or a mixture comprising at least one first linear 1,2-alkanediol having a carbon chain of 10 to 13 carbon atoms and one or more second linear 1,2-alkanediols having a carbon chain of 10 to 13 carbon atoms, which is different from the first linear 1,2-alkanediol.

In a still more preferred variant, the dish cleaning and/or rinsing composition according to the present invention comprises at least one boosting agent selected from the group consisting of at least one linear alkanediol having a carbon chain of 11 to 12 atoms, or a mixture comprising at least one first linear alkanediol having a carbon chain of 11 to 12 carbon atoms and one or more second linear alkanediols having a carbon chain of 11 to 12 carbon atoms, which is different from the first linear alkanediol.

Surprisingly, it was found that these long-chain 1,2-alkanediols are particularly suitable boosting and/or anti-spotting agents and which can also efficiently be incorporated into a dish cleaning and/or compositions, or which can be used as anti-spotting agents as such.

It was found that these substances show better cleaning and rinsing properties and significantly reduce remaining deposits and/or spotting. Such compositions show improved cleaning, and, in particular, rinsing properties with considerably reduced spotting compared to compositions without the addition of such substances.

In a further preferred variant, the dish cleaning and/or dish rinsing composition according to the present invention comprises at least one boosting agent selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of ≤1, which is different from the first linear 1,2-alkanediol.

The 1,2-alkanediols having a log Pow value of ≤1 are selected from the group consisting of 1,2-pentanediol (log Pow=0.06), 1,2-hexanediol (log Pow=0.58), 1,2-heptanediol (log Pow=0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:

$$Log Pow = log 10 ( Partition Coefficient )$$

$$Partition Coefficient , P = [ n - octanol ] / [ water ]$$

where [ ] indicates the concentration of solute in the organic and/or aqueous partition.
The log Pow value is determined at a standard temperature of 25° C.

The log Pow value s 1 means the compound has a higher affinity for the aqueous phase (it is more hydrophilic) and, thus, more soluble in water; a log Pow value 1 denotes a higher concentration in the lipid phase (i.e., the compound is more lipophilic) and, thus, more soluble in fat-like solvents.

Surprisingly, it was found that 1,2-alkanediols having a Pow value of ≤1 are particularly suitable boosting agents, which can also efficiently be incorporated into a broad range of dish cleaning and/or rinsing compositions. In addition, it was found that the aforesaid 1,2-alkanediols exhibit outstanding improved anti-spotting properties in a dish cleaning and/or rinsing composition as specified herein. Thus, dish cleaning and/or rinsing compositions comprising 1,2-alkanediols having a Pow value of ≤1 show improved cleaning properties with considerably reduced water spotting upon drying compared to compositions without the addition of such 1,2-alkanediols.

In a still further preferred variant, the dish cleaning and/or rinsing composition according to the present invention comprises at least one boosting agent selected from the group consisting of at least one linear 1,2-alkanediol having a log Pow value of ≥1, or a mixture comprising at least one first linear 1,2-alkanediol having a log Pow value of ≥1 and one or more second linear 1,2-alkanediol having a log Pow value of ≥1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, 1,2-dodecanediol, 1,2-tridecanediol, 1,2-tetradecanediol, and any mixture thereof. Said 1,2-alkanediols are more soluble in fat-like solvents, for example n-octanol.

Surprisingly, it was found that 1,2-alkanediols having a Pow value of ≥1 are suitable boosting agents, which can also efficiently be incorporated into a broad range of dish cleaning and/or rinsing compositions. In addition, it was found that the aforesaid 1,2-alkanediols exhibit outstanding improved anti-spotting properties in a dish cleaning and/or rinsing composition. Thus, dish cleaning and/or rinsing compositions comprising 1,2-alkanediols having a Pow value of ≥1 show improved cleaning properties with considerably reduced water spotting upon drying compared to compositions without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 14 carbon atoms or the second linear alkanediol having a carbon chain of 5 to 14 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” include both the corresponding S-configured enantiomers and also the R-enantiomer as well as arbitrary mixtures of these S- and R-configured enantiomers, i.e. mixtures of racemates of the respective diols.

The alkanediol mixture of the dish cleaning and/or rinsing composition according to the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the dish cleaning and/or rinsing composition according to the present invention, 1,2-heptanediol and 2,3-heptanediol are comprised in the mixture preferably in a ratio in a range of 98:2 to 99.9:0.1.

In the dish cleaning and/or rinsing compositions according to the present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the dish cleaning and/or rinsing composition according to the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the dish cleaning and/or rinsing composition according to the present invention comprises 1,2-heptanediol and 2,3-heptanediol in a ratio of ≥95:≤5, including the ratios ≥95.5:≤4.5; ≥96:≤4; ≥96.5:≤3.5; ≥97:≤3; ≥97.5:≤2.5 and ≥98.0:≤2.0.

Even more preferred the alkanediol mixture of the dish cleaning and/or rinsing composition according to the present invention comprises 1,2-heptanediol and 2,3-heptanediol in a ratio of ≥98:≤2, including the ratios of 98.1:≤1.9; 98.2:≤1.8; 98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; 99.7:≤0.3; ≥99.8:≤0.2 and ≥99.9:≤0.1.

The at least one first linear alkanediol and the one or more second linear alkanediol as defined in detail above, are present in the alkanediol mixture according to the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the dish cleaning and/or rinsing composition according to the present invention, the at least one first linear alkanediol and the one or more second linear alkanediol are comprised in the mixture preferably in a ratio in a range of 98:2 to 99.9:0.1

In the dish cleaning and/or rinsing composition according to the present invention, the at least one first linear alkanediol and the one or more second alkanediol are comprised in the alkanediol mixture preferably in a ratio in a range of 95:5 to 99.9:0.1.

Preferably, the at least one first linear alkanediol and the one or more second alkanediol are comprised in the mixture of the dish cleaning and/or rinsing composition according to the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the dish cleaning and/or rinsing composition according to the present invention comprises the at least one first linear alkanediol and the one or more second linear alkanediol in a ratio of ≥95:≤5, including the ratios ≥95.5:≤4.5; ≥96:≤4; ≥96.5:≤3.5; ≥97:≤3; ≥97.5:≤2.5 and ≥98.0:≤2.0.

Even more preferred the alkanediol mixture of the dish cleaning and/or rinsing composition according to the present invention comprises the at least one first linear alkanediol and the one or more second alkanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

Alternatively, said ratio ranges for the first and second alkanediol are switched, such that the one or more second alkanediol is the main component and the at least one first alkanediol is the secondary component.

In an advantageous variant according to the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a still further preferred variant, according to the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a more advantageous variant according to the present invention, in the alkanediol mixtures comprising a combination of a 1,2-alkanediol as first linear alkanediol and the corresponding 2,3-alkanediol as second linear alkanediol, such as:
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,3-decanediol, or
1,2-undecanediol and 2,3-undecanediol, or
1,2-dodecanediol and 2,3-dodecanediol, or
1,2-tridecanediol and 2,3-tridecanediol, or
1,2-tetradecanediol and 2,3-tetradecanediol,
the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol:second alkanediol or ranges of ratios as described above are also applicable.

By these mixing ratios the afore mentioned alkanediol mixtures show a synergistically intensified cleaning and/or drying/rinsing effect with considerably reduced water spotting in comparison with the corresponding individual substances.

A preferred variant according to the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to further preferred embodiment the present invention relates to a dish cleaning and/or rinsing composition as specified herein, wherein the at least one linear alkanediol or the at least one first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or wherein the one or more second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to another preferred variant, the present invention relates to a dish cleaning and/or rinsing composition as specified herein,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of ≥90:10 to 95:5; or
(ii) wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of ≥90:10 to 95:5.

By these mixing ratios the afore mentioned mixtures show a synergistical boosting of the cleaning and/or drying/rinsing performance with considerably reduced water spotting in a dish cleaning and/or rinsing composition comprising in direct comparison with the corresponding individual alkanediol substances.

According to a particularly preferred variant the dish cleaning and/or rinsing composition, comprises at least one boosting agent selected from the group consisting of at least one linear alkanediol having a carbon chain of 10 to 14 carbon atoms, or a mixture comprising at least one first linear alkanediol having a carbon chain of 10 to 14 carbon atoms and one or more second linear alkanediols having a carbon chain of 10 to 14 carbon atoms which is different from the first linear alkanediol.

Surprisingly, if was found that these long-chain alkanediols are particularly suitable anti-spotting agents as such which also can efficiently be incorporated into a broad range of compositions. It was found that these substances show improved film-forming properties and thereby reduce the occurrence of spotting efficiently due to a more uniform drying resulting in high shine and overall improved finishing properties and additionally show improved cleaning properties and efficiently prevent the redeposition of soil, thus, reducing the formation of deposits on the washed items and allow for an efficient cleaning.

The alkanediols are obtained either by synthesis from petrochemical or other fossil fuel sources by known methods such as olefin bishydroxylation, hydrolysis from epoxide or various chemical transformations or from bioderived feedstock by fermentation or from bio-based natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the boosting agent of the dish cleaning and/or rinsing composition according to the present invention is either (a^{II}) glyceryl caprylate, or (a^{III}) 4-hydroxyacetophenone, or (a^{IV}) ethyl hexyl glycerin, or (a^{V}) tropolone, or any mixture of the aforementioned boosting agents.

Glyceryl Caprylate (a^{II}):

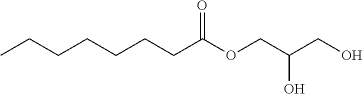

is a natural emollient derived from glycerine and plant fatty acids, usually appearing as a white waxy solid. This ingredient is used in many skincare products for its emollient and moisturizing properties, to help maintain the balance of moisture in the skin. In additional, glyceryl caprylate (a^{II}) is used as antimicrobial active component in cosmetic preparations.

It was surprisingly found that the oily, surface-active co-emulsifier glyceryl caprylate is a further suitable boosting agent within the meaning of the present invention.

4-Hydroxyacetophenone, 4-HAP (a^{III}):

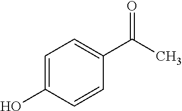

possesses oxidation-inhibiting, fungicidal and bacterial growth-inhibiting properties and is therefore used to stabilize cosmetic preparations. 4-Hydroxyacetophenone (4-HAP or piceol) is a naturally occurring and biodegradable substance which is generally recognized as being safe. 4-Hydroxyacetophenone has oxidation-inhibiting, fungicidal and bacterial growth-inhibiting properties.

It was surprisingly found that 4-HAP is a further suitable boosting agent within the meaning of the present invention.

Ethyl Hexyl Glycerin, EHG (a^{IV}):

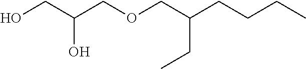

is a relatively new cosmetic ingredient that is used for its surfactant, dispersant, emollient, skin-conditioning and antimicrobial properties. Ethyl hexyl glycerin (EHG or octoxyglycerin) is a glyceryl ether and a vicinal diol.

It was surprisingly found that EHG is a further suitable boosting agent within the meaning of the present invention.

### Tropolone (a^{V}):

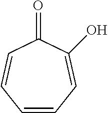

is known for its antibacterial, antifungal, anti-inflammatory, antioxidant, and chelating properties and is therefore used in cosmetic formulations.

It was surprisingly found that tropolone is a further suitable boosting agent within the meaning of the present invention.

The above specified boosting agents (a^{II}), (a^{III}), (a^{IV}) and (a^{V}) can be used either individually or in the form of mixtures of two, three, or even more boosting agents.

Similarly, the above specified single boosting agents (a^{II}) (a^{III}), (a^{IV}) and (a^{V}) or mixtures of two or three boosting agents (a^{II}) (a^{III}), (a^{IV}) and (a^{V}) can also be used in admixture with the alkanediol boosting agent(s) (a^{I}) as defined herein. Preferably, such mixtures contain two, or even more boosting agents as defined herein.

In a particular preferred variant of the dish cleaning and/or rinsing composition according to the present invention the at least one boosting agent (a) includes any of the following mixtures/combinations:
a mixture comprising (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (a^{II}) glyceryl caprylate;
a mixture comprising (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (a^{III}) 4-hydroxyacetophenone;
a mixture comprising (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (a^{IV}) ethyl hexyl glycerin;
a mixture comprising (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol, as defined above, and (a^{V}) tropolone;
a mixture comprising (a^{II}) glyceryl caprylate and (a^{III}) 4-hydroxyacetophenone;
a mixture comprising (a^{II}) glyceryl caprylate and (a^{IV}) ethyl hexyl glycerin;
a mixture comprising (a^{II}) glyceryl caprylate and (a^{V}) tropolone;
a mixture comprising (a^{III}) 4-hydroxyacetophenone and (a^{IV}) ethyl hexyl glycerin;
a mixture comprising (a^{III}) 4-hydroxyacetophenone and (a^{V}) tropolone; and
a mixture comprising (a^{IV}) ethyl hexyl glycerin and (a^{V}) tropolone.

In a preferred variant, the dish cleaning and/or rinsing composition according to the present invention includes any of the following boosting agent mixtures/combinations selected from the group consisting of:
a mixture comprising (a^{II}) glyceryl caprylate and 1,2-pentanediol;
a mixture comprising (a^{II}) glyceryl caprylate and 1,2-hexanediol;
a mixture comprising (a^{II}) glyceryl caprylate and 1,2-heptanediol;
a mixture comprising (a^{II}) glyceryl caprylate and 1,2-octanediol;
a mixture comprising (a^{II}) glyceryl caprylate and 1,2-nonanediol;
a mixture comprising (a^{II}) glyceryl caprylate and 1,2-decanediol;
a mixture comprising (a^{II}) glyceryl caprylate and 1,2-undecanediol;
a mixture comprising (a^{II}) glyceryl caprylate and 1,2-dodecanediol;
a mixture comprising (a^{II}) glyceryl caprylate and 1,2-tridecanediol;
a mixture comprising (a^{II}) glyceryl caprylate and 1,2-tetradecanediol;
a mixture comprising (a^{III}) 4-hydroxyacetophenone and 1,2-pentanediol;
a mixture comprising (a^{III}) 4-hydroxyacetophenone and 1,2-hexanediol;
a mixture comprising (a^{III}) 4-hydroxyacetophenone and 1,2-heptanediol;
a mixture comprising (a^{III}) 4-hydroxyacetophenone and 1,2-octanediol;
a mixture comprising (a^{III}) 4-hydroxyacetophenone and 1,2-nonanediol;
a mixture comprising (a^{III}) 4-hydroxyacetophenone and 1,2-decanediol;
a mixture comprising (a^{III}) 4-hydroxyacetophenone and 1,2-undecanediol;
a mixture comprising (a^{III}) 4-hydroxyacetophenone and 1,2-dodecanediol;
a mixture comprising (a^{III}) 4-hydroxyacetophenone and 1,2-tridecanediol;
a mixture comprising (a^{III}) 4-hydroxyacetophenone and 1,2-tetradecanediol;
a mixture comprising (a^{IV}) ethyl hexyl glycerin and 1,2-pentanediol;
a mixture comprising (a^{IV}) ethyl hexyl glycerin and 1,2-hexanediol;
a mixture comprising (a^{IV}) ethyl hexyl glycerin and 1,2-heptanediol;
a mixture comprising (a^{IV}) ethyl hexyl glycerin and 1,2-octanediol;
a mixture comprising (a^{IV}) ethyl hexyl glycerin and 1,2-nonanediol;
a mixture comprising (a^{IV}) ethyl hexyl glycerin and 1,2-decanediol;
a mixture comprising (a^{IV}) ethyl hexyl glycerin and 1,2-undecanediol;
a mixture comprising (a^{IV}) ethyl hexyl glycerin and 1,2-dodecanediol;
a mixture comprising (a^{IV}) ethyl hexyl glycerin and 1,2-tridecanediol;
a mixture comprising (a^{IV}) ethyl hexyl glycerin and 1,2-tetradecanediol;
a mixture comprising (a^{V}) tropolone and 1,2-pentanediol;
a mixture comprising (a^{V}) tropolone and 1,2-hexanediol;
a mixture comprising (a^{V}) tropolone and 1,2-heptanediol;
a mixture comprising (a^{V}) tropolone and 1,2-octanediol;
a mixture comprising (a^{V}) tropolone and 1,2-nonanediol;
a mixture comprising (a^{V}) tropolone and 1,2-decanediol;
a mixture comprising (a^{V}) tropolone and 1,2-undecanediol;
a mixture comprising (a^{V}) tropolone and 1,2-dodecanediol;
a mixture comprising (a^{V}) tropolone and 1,2-tridecanediol;
a mixture comprising (a^{V}) tropolone and 1,2-tetradecanediol.

Surprisingly, it was found that the above specified combinations are particularly efficient in terms of drying/rinsing boost, and cleaning performance and can efficiently be incorporated into a broad range of dish cleaning and/or rinsing compositions. It was found that these boosting mixtures show an outstanding synergistic boosting effect.

It was surprisingly discovered that adding a boosting agent or a mixture of boosting agents as specified above can boost the cleaning performance and/or the rinsing/drying performance in a dish cleaning and/or rinsing composition by simultaneously considerably reducing the formation of water spotting upon drying. This boosting effect, in particular in view of the improved anti-spotting performance of the compositions disclosed herein provides for the desired gloss without streaks. The compositions disclosed herein efficiently remove deposits such as food residues or grease and simultaneously help efficiently removing water from the washed items such as flatware, plates, bowls, and glasses and thereby enhancing the appearance of the washed items after drying by suppressing the formation of filming and/or spotting, especially in view of plastic-based items, stainless steel items and glassware.

The improved removal of water from the washed surfaces is based on a reduced surface tension of the water remaining on the surfaces after washing. This causes the water to dry in thin sheets rather than form discrete droplets which would cause water spotting once the water evaporates due to the remaining minerals. Additionally, the drying process is accelerated. This results in an overall improved drying performance. The compositions according to the present invention thus do not merely act as rinsing agents but also as drying aids.

Thus, based on the combined effect of efficiently cleaning (reduction of deposits) and the improved rinsing/drying properties (improved drying with reduction of water spotting) the compositions according to the present invention are highly suitable dish cleaning and/or rinsing compositions, in particular for use in an automatic dishwasher. In addition, the compositions as defined herein can be used as efficient anti-spotting agents.

A particular pronounced boosting effect in view of the rinsing properties can be observed for the following boosting agents:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

For the dish cleaning and/or rinsing compositions according to the present invention, the list of boosting agents (a) as specified herein can be arbitrary combined with the list of surfactants (b) specified herein.

For the dish cleaning and/or rinsing compositions according to the present invention, the list of boosting agents (a) as specified herein can be arbitrary combined with the list of enzymes (c) specified herein.

For the dish cleaning and/or rinsing compositions according to the present invention, the list of surfactants (b) as specified herein can be arbitrary combined with the list of enzymes (c) specified herein.

The 1,2-heptanediol (a1) or the 2,3-heptanediol (a2) or the mixture comprising 1,2-heptanediol and 2,3-heptanediol (a3) according to the present invention is present in the dish cleaning and/or rinsing composition in an amount of 0.001% to 15.0% by weight, based on the total weight of the composition. In a preferred variant, the dish cleaning and/or rinsing composition comprises the 1,2-heptanediol (a1) or the 2,3-heptanediol (a2) or the mixture comprising 1,2-heptanediol and 2,3-heptanediol (a3) in an amount of 0.01% to 10.0% by weight, based on the total weight of the composition. In a more preferred variant, the 1,2-heptanediol (a1) or 2,3-heptanediol (a2) or the mixture comprising 1,2-heptanediol and 2,3-heptanediol (a3) is advantageously used in the dish cleaning and/or rinsing composition in an amount of at 0.1% to 5.0% by weight, based on the total weight of the composition. In a still more preferred variant, the 1,2-heptanediol (a1) or 2,3-heptanediol (a2) or the mixture comprising 1,2-heptanediol and 2,3-heptanediol (a3) is advantageously used in the dish cleaning and/or rinsing composition in an amount of at 0.3% to 3.0% by weight, based on the total weight of the composition. In a most preferred variant, the 1,2-heptanediol (a1) or 2,3-heptanediol (a2) or the mixture comprising 1,2-heptanediol and 2,3-heptanediol (a3) is advantageously used in the dish cleaning and/or rinsing composition in an amount of at 0.5% to 1.0% by weight, based on the total weight of the composition.

For the heptanediol mixture (a3), the above amounts relate to the total content of the 1,2-heptanediol and the 2,3-heptanediol in the mixture, i.e. the amount is the sum of the content of 1,2-heptanediol and 2,3-heptanediol in the mixture.

The at least one boosting agent (a) according to the present invention is present in the dish cleaning and/or rinsing composition in an amount of 0.001% to 15.0% by weight, based on the total weight of the composition. In a preferred variant, the dish cleaning and/or rinsing composition comprises the at least one boosting agent (a) in an amount of 0.01% to 10.0% by weight, based on the total weight of the composition. In a more preferred variant, the at least one boosting agent (a) is advantageously used in the dish cleaning and/or rinsing composition in an amount of at 0.1% to 5.0% by weight, based on the total weight of the composition. In a still more preferred variant, the at least one boosting agent (a) is advantageously used in the dish cleaning and/or rinsing composition in an amount of at 0.3% to 3.0% by weight, based on the total weight of the composition. In a most preferred variant, the at least one boosting agent (a) is advantageously used in the dish cleaning and/or rinsing composition in an amount of at 0.5% to 1.0% by weight, based on the total weight of the composition.

Therefore, the present invention further relates to a dish cleaning and/or rinsing composition according to the invention, comprising the 1,2-heptanediol (a1) or the 2,3-heptanediol (a2) or the mixture comprising 1,2-heptanediol and 2,3-heptanediol (a3) or the at least one boosting agent (a) in an amount of 0.001% to 15.0% by weight, preferred in an amount of 0.01% to 10.0% by weight, more preferred in an amount of 0.1% to 5.0% by weight, still more preferred in an amount of 0.3% to 3.0% by weight, most preferred in an amount of 0.5% to 1.0% by weight, based on the total weight of the composition.

For the alkanediol mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol(s) and the second linear alkanediol(s) in the mixture.

In a particular preferred variant according to the present invention, the dish cleaning and/or rinsing composition comprises the 2,3-heptanediol or the 2,3-heptanediol of the mixture comprising 1,2-heptanediol and 2,3-heptanediol (a3) in an amount of 0.001% to 15.0% by weight, preferred in an amount of 0.01% to 10.0% by weight, more preferred in an amount of 0.1% to 5.0% by weight, still more preferred in an amount of 0.3% to 3.0% by weight, and most preferred in an amount of 0.5% to 1.0% by weight, based on the total weight of the composition.

Even more preferred, the dish cleaning and/or rinsing composition comprises the 2,3-heptanediol or the 2,3-heptanediol of the mixture comprising 1,2-heptanediol and 2,3-heptanediol (a3) in an amount of 0.001% to 0.5% weight, preferably in an amount of 0.005% to 0.1% by weight and most preferably in an amount of 0.01% to 0.075% by weight, based on the total weight of the composition or product.

In a particular preferred variant according to the present invention, the dish cleaning and/or rinsing composition comprises the 2,3-alkanediol as the at least one linear alkanediol or of the mixture comprising at least one first linear alkanediol and one or more second linear alkanediol in an amount of 0.001% to 15.0% by weight, preferably in an amount of 0.01% to 10.0% by weight, more preferred in an amount of 0.1% to 5.0% by weight, still more preferred in an amount of 0.3% to 3.0% by weight, and most preferred in an amount of 0.5% to 1.0% by weight, based on the total weight of the composition or product.

Even more preferred, the dish cleaning and/or rinsing composition comprises the 2,3-alkanediol as linear alkanediol or of the mixture comprising at least one first linear alkanediol and one or more second linear alkanediol in an amount of 0.001% to 0.5% weight, preferably in an amount of 0.005% to 0.1% by weight and most preferably in an amount of 0.01% to 0.075% by weight, based on the total weight of the composition or product.

In a further preferred variant, the dish cleaning and/or rinsing composition comprises the (a^{II}) glyceryl caprylate and/or (a^{III}) 4-hydroxyacetophenone and/or (a^{IV}) ethyl hexyl glycerin and/or (a^{V}) tropolone in an amount of 0.001% to 15.0% by weight, preferably in an amount of 0.01% to 10.0% by weight, more preferred in an amount of 0.1% to 5.0% by weight, still more preferred in an amount of 0.3% to 3.0% by weight, and most preferred in an amount of 0.5% to 1.0% by weight, based on the total weight of the composition or product.

For the above-mentioned mixture of boosting agents, the above amounts relate to the total content of the boosting agents in the composition, i.e. the amount is the sum of the content of all boosting agents in the composition.

In an alternative preferred variant, the dish cleaning and/or rinsing composition comprises the (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol in combination with the (a^{II}) glyceryl caprylate and/or (a^{III}) 4-hydroxyacetophenone and/or (a^{IV}) ethyl hexyl glycerin and/or (a^{V}) tropolone in an amount of 0.001% to 15.0% by weight, preferably in an amount of 0.01% to 10.0% by weight, more preferred in an amount of 0.1% to 5.0% by weight, still more preferred in an amount of 0.3% to 3.0% by weight, and most preferred in an amount of 0.5% to 1.0% by weight, based on the total weight of the composition or product.

For the above-mentioned mixture of boosting agents, the above amounts relate to the total content of the boosting agents in the composition, i.e. the amount is the sum of the content of all boosting agents in the composition.

For the dish cleaning and/or rinsing compositions according to the present invention, the list of boosting agents specified herein can be arbitrary combined with the list of surfactants specified herein.

Surfactants/Component (b), (b1), (b2), (b3)

The dish cleaning and/or rinsing compositions according to the present invention further includes at least one surfactant (component (b1), (b2), (b3), (b)).

Surfactants are added for a number of reasons, the main purposes being their washing and surface-active properties. They remove soils from the dish ware or their surfaces and keep it suspended in the washing solution. Some surfactants perform by way of other function such as foam inhibition.

It was surprisingly found that the combination of specific surfactants (b) and boosting agents (a) as specified herein synergistically boosts the cleaning performance of the composition.

Moreover, it was found that the combination of surfactants (b) as specified herein with boosting agents (a) as specified herein efficiently improves the rinsing and drying performance in a synergistical manner.

Both effects are particularly pronounced when used in automatic dishwashing.

The dish cleaning and/or rinsing compositions according to the present invention preferably comprise the at least one surfactant in an amount of 0.001% to 40% by weight, based on the total weight of the composition. Preferably, the surfactant is present in an amount of 0.005% to 30% by weight, based on the total weight of the composition. More preferred, the dish cleaning and/or rinsing composition according to the present invention comprises the surfactant in an amount of 0.01% to 25% by weight and most preferred in an amount of 0.1% to 20% by weight, based on the total weight of the composition.

The preferred solvent, if required, is water, which can be present in gel-like compositions in amounts typically ranging from about 10% to about 60% by weight and preferably from about 20% to about 35% by weight in more concentrated products.

In liquid formulations and rinsing compositions such as rinse aids according to the present invention, the water content can even range up to 95% by weight and usually from approximately 50% to 95% by weight. In solid compositions the water content is correspondingly considerably lower.

In the dish cleaning and rinsing compositions according to the present invention for automatic dishwashing, the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols.

These surfactants are different from the ones used in manual dishwashing. Based on the above mentioned surfactants, the dish cleaning and rinsing composition according to the present invention provides for excellent cleaning properties in combination with excellent rinsing and drying properties in automatic dishwashing for a broad range of materials such as glass-based items, plastic-based items or steel-based item.

The dish rinsing compositions according to the present invention may comprise any kind of surfactant, namely anionic, cationic, non-ionic, amphoteric or zwitterionic surfactants and their mixtures. However, preferably the same surfactants are used as are specified for the dish cleaning and rinsing compositions according to the present invention.

Thus, according to a further preferred embodiment of the present invention the at least one surfactant comprised in the dish rinsing compositions is selected from the group consisting of non-ionic surfactants, anionic surfactants, amphoteric surfactants/zwitterionic surfactants, cationic surfactants, and any mixtures thereof. However, preferably the at least one surfactant is selected from the group of non-ionic and/or anionic surfactants as specified herein.

Suitable surfactants which can be incorporated into the rinsing compositions according to the present invention are:

### Anionic Surfactants:

Suitable anionic surfactants for the dish rinsing composition according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide; and any mixture thereof.

In a preferred variant of the dish rinsing composition according to the present invention, the anionic surfactant is selected from the group consisting of:
C10 to C13 alkyl benzene sulfonates;
C12 to C15 alkyl sulfates;
C12 to C14 alkyl sulfates, ethoxylated with 1 to 3 moles ethylene oxide;
C12 to C16 alpha-olefin sulfonates;
C8 to C18 alkyl carboxylates, ethoxylated with 3 to 10 moles ethylene oxide, and preferably ethoxylated with 3 to 6 moles ethylene oxide;
and any mixture thereof.

In a more preferred variant of the dish rinsing composition according to the present invention, the anionic surfactant is selected from the group consisting of:
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
and any mixture thereof.

According to a still further preferred variant of the dish rinsing composition according to the present invention, the anionic surfactant is selected from the group consisting of dodecyl sulfate, dodecyl sulfate ethoxylated with 2 moles ethylene oxide, and the mixture thereof.

### Cationic Surfactants:

Suitable cationic surfactants for the dish rinsing composition according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the dish rinsing composition according to the present invention, the cationic surfactant is selected from the group consisting of:
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the dish rinsing composition according to the present invention, the cationic surfactant is selected from the group consisting of:
quaternary C16 to C18 alkyl ethanolamines;
quaternary C16 to C18 alkyl ammonium compounds;
C14 to C18 alkyl ammonium methosulfates;
   and any mixture thereof.

### Non-Ionic Surfactants:

Suitable non-ionic surfactants for the dish rinsing composition according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as:
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide, and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the dish rinsing composition according to the present invention, the non-ionic surfactant is selected from the group consisting of:
C8 to C15 fatty alcohols, ethoxylated with 3 to 8 moles ethylene oxide;
alkoxylated C8 to C15 fatty alcohols such as:
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide, and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a further preferred variant of the dish rinsing composition according to the present invention, the non-ionic surfactant is selected from the group consisting of:
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a most preferred variant of the dish rinsing composition according to the present invention, the non-ionic surfactant is selected from the group consisting of: C10 to C18 sophorolipids, C10 to C18 rhamnolipids, C8 to C14 alkyl polyglycosides, and any mixture thereof.

However, the at least one surfactant of the rinsing composition can be the same as the at least one surfactant of the cleaning and rinsing composition, i.e. the surfactant can be at least one of the surfactants specified for the cleaning and rinsing composition.

For automatic dishwashing, the non-ionic surfactant is most preferred selected from the group consisting of C12 to C14 fatty alcohols, ethoxylated with 5 mol ethylene oxide and/or propoxylated with 4 mol propylene oxide.

In the dish cleaning and rinsing composition according to the present invention, the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols.

Accordingly, in the cleaning and rinsing composition according to the present invention, the at least one surfactant is a non-ionic surfactant selected from the group consisting of C6 to C18 fatty alcohols propoxylated with 1 to 15 moles propylene oxide and/or ethoxylated with 1 to 25 moles ethylene oxide and/or butoxylated with 1 to 10 moles butylene oxide.

Further preferred the at least one non-ionic surfactant is selected from the group consisting of C6 to 18 fatty alcohols propoxylated with 1 to 10 moles propylene oxide, and more preferred propoxylated with 1 to 6 moles propylene oxide, and most preferred propoxylated with 4 to 6 moles propylene oxide. According to a most preferred variant, in the dish cleaning and rinsing composition according to the present invention, the surfactant is a non-ionic surfactant selected from the group consisting of C6 to C18 fatty alcohols, propoxylated with 4 moles propylene oxide.

In a more preferred variant, in the dish cleaning and rinsing composition according to the present invention, the at least one surfactant is a non-ionic surfactant selected from the group consisting of C12 to C18 fatty alcohols, propoxylated with 1 to 15 moles propylene oxide.

Further preferred the non-ionic surfactant is selected from the group consisting of C12 to 18 fatty alcohols propoxylated with 1 to 10 moles propylene oxide, and more preferred propoxylated with 1 to 6 moles propylene oxide, and most preferred propoxylated with 4 to 6 moles propylene oxide. According to a most preferred variant, the dish cleaning and rinsing composition according to the present invention, the surfactant is a non-ionic surfactant selected from the group consisting of C12 to C18 fatty alcohols, propoxylated with 4 moles propylene oxide.

In an even more preferred variant, in the dish cleaning and rinsing composition according to the present invention, the at least one surfactant is a non-ionic surfactant selected from the group consisting of C12 to C14 fatty alcohols, propoxylated with 1 to 15 moles propylene oxide. Further preferred the non-ionic surfactant is selected from the group consisting of C12 to 18 fatty alcohols propoxylated with 1 to 10 moles propylene oxide, and more preferred propoxylated with 1 to 6 moles propylene oxide, and most preferred propoxylated with 4 to 6 moles propylene oxide. According to a most preferred variant, the dish cleaning and rinsing composition according to the present invention, the surfactant is a non-ionic surfactant selected from the group consisting of C12 to C14 fatty alcohols, propoxylated with 4 moles propylene oxide.

In case of the dish cleaning and rinsing composition according to the present invention, wherein the at least one surfactant is a non-ionic surfactant selected from the group consisting of C6 to C18 fatty alcohols, propoxylated with 1 to 15 moles propylene oxide or the preferred variants, also a mixture of these propoxylated surfactants can be used.

Further preferred the at least one non-ionic surfactant is selected from the group consisting of C6 to 18 fatty alcohols ethoxylated with 1 to 25 moles ethylene oxide, and more preferred ethoxylated with 1 to 20 moles ethylene oxide, and further preferred ethoxylated with 1 to 15 moles ethylene oxide, and most preferred ethoxylated with 1 to 10 moles ethylene oxide, and even more preferred ethoxylated with 1 to 5 moles ethylene oxide. According to a most preferred variant, in the dish cleaning and rinsing composition according to the present invention, the surfactant is a non-ionic surfactant selected from the group consisting of C6 to C18 fatty alcohols, ethoxylated with 5 moles ethylene oxide.

In a more preferred variant, in the dish cleaning and rinsing composition according to the present invention, the at least one non-ionic surfactant is selected from the group consisting of C12 to 18 fatty alcohols ethoxylated with 1 to 25 moles ethylene oxide, and more preferred ethoxylated with 1 to 20 moles ethylene oxide, and further preferred ethoxylated with 1 to 15 moles ethylene oxide, and most preferred ethoxylated with 1 to 10 moles ethylene oxide, and even more preferred ethoxylated with 1 to 5 moles ethylene oxide. According to a most preferred variant, in the dish cleaning and rinsing composition according to the present invention, the surfactant is a non-ionic surfactant selected from the group consisting of C12 to C18 fatty alcohols, ethoxylated with 5 moles ethylene oxide.

In an even more preferred variant, in the dish cleaning and rinsing composition according to the present invention, the at least one non-ionic surfactant is selected from the group consisting of C12 to 14 fatty alcohols ethoxylated with 1 to 25 moles ethylene oxide, and more preferred ethoxylated with 1 to 20 moles ethylene oxide, and further preferred ethoxylated with 1 to 15 moles ethylene oxide, and most preferred ethoxylated with 1 to 10 moles ethylene oxide, and even more preferred ethoxylated with 1 to 5 moles ethylene oxide.

According to a most preferred variant, in the dish cleaning and rinsing composition according to the present invention, the surfactant is a non-ionic surfactant selected from the group consisting of C12 to C14 fatty alcohols, ethoxylated with 5 moles ethylene oxide.

In case of the dish cleaning and rinsing composition according to the present invention, wherein the at least one surfactant is a non-ionic surfactant selected from the group consisting of C6 to C18 fatty alcohols ethoxylated with 1 to 25 moles ethylene oxide or the preferred variants, also a mixture of these ethoxylated surfactants can be used.

Further preferred the at least one non-ionic surfactant is selected from the group consisting of C6 to 18 fatty alcohols butoxylated with 1 to 10 moles butylene oxide, and more preferred butoxylated with 1 to 6 moles butylene oxide, and most preferred butoxylated with 4 to 6 moles butylene oxide. According to a most preferred variant, in the dish cleaning and rinsing composition according to the present invention, the surfactant is a non-ionic surfactant selected from the group consisting of C6 to C18 fatty alcohols, butoxylated with 4 moles butylene oxide.

In a more preferred variant, in the dish cleaning and rinsing composition according to the present invention, the at least one surfactant is a non-ionic surfactant selected from the group consisting of C12 to C18 fatty alcohols, butoxylated with 1 to 15 moles butylene oxide.

Further preferred the non-ionic surfactant is selected from the group consisting of C12 to 18 fatty alcohols butoxylated with 1 to 10 moles butylene oxide, and more preferred butoxylated with 1 to 6 moles butylene oxide, and most preferred butoxylated with 4 to 6 moles butylene oxide. According to a most preferred variant, the dish cleaning and rinsing composition according to the present invention, the surfactant is a non-ionic surfactant selected from the group consisting of C12 to C18 fatty alcohols, butoxylated with 4 moles butylene oxide.

In an even more preferred variant, in the dish cleaning and rinsing composition according to the present invention, the at least one surfactant is a non-ionic surfactant selected from the group consisting of C12 to C14 fatty alcohols, butoxylated with 1 to 15 moles butylene oxide. Further preferred the non-ionic surfactant is selected from the group consisting of C12 to 18 fatty alcohols butoxylated with 1 to 10 moles butylene oxide, and more preferred butoxylated with 1 to 6 moles butylene oxide, and most preferred butoxylated with 4 to 6 moles butylene oxide. According to a most preferred variant, the dish cleaning and rinsing composition according to the present invention, the surfactant is a non-ionic surfactant selected from the group consisting of C12 to C14 fatty alcohols, butoxylated with 4 moles butylene oxide.

In case of the dish cleaning and rinsing composition according to the present invention, wherein the at least one surfactant is a non-ionic surfactant selected from the group consisting of C6 to C18 fatty alcohols butoxylated with 1 to 10 moles butylene oxide or the preferred variants, also a mixture of these butoxylated surfactants can be used.

In a particular preferred variant of the dish cleaning and rinsing composition according to the present invention, the at least one non-ionic surfactant includes any of the following mixtures/combinations:
at least one surfactant selected from the group consisting of C6 to C18 fatty alcohols propoxylated with 1 to 15 moles propylene oxide in combination with at least one surfactant selected from the group consisting of C6 to C18 fatty alcohols ethoxylated with 1 to 25 moles ethylene oxide;
at least one surfactant selected from the group consisting of C6 to C18 fatty alcohols propoxylated with 1 to 15 moles propylene oxide in combination with at least one surfactant selected from the group consisting of C6 to C18 fatty alcohols butoxylated with 1 to 10 moles butylene oxide;
at least one surfactant selected from the group consisting of C6 to C18 fatty alcohols ethoxylated with 1 to 25 moles ethylene oxide; in combination with at least one surfactant selected from the group consisting of C6 to C18 fatty alcohols butoxylated with 1 to 10 moles butylene oxide.

For these combinations of surfactants, the above-mentioned preferred ranges apply likewise.

Accordingly, the surfactant component (b) of the dish cleaning and rinsing composition can be based on a mixture of different surfactants. These surfactants can differ in their chain length and/or can differ in the moles of functionalization (i.e. the moles of ethylene oxide, the moles of propylene oxide, the moles of butylene oxide) and/or can differ in the type of the functionalization (propoxylation, ethoxylation, butoxylation).

Preferably, in the dish cleaning and rinsing composition according to the present invention the at least one surfactant is selected from the group of C6 to C18 fatty alcohols butoxylated with 1 to 10 moles butylene oxide. More preferred, in the dish cleaning and rinsing composition according to the present invention the at least one surfactant is selected from the group of C6 to C18 fatty alcohols propoxylated with 1 to 15 moles propylene oxide, and further preferred from the group of C6 to C18 fatty alcohols ethoxylated with 1 to 25 moles ethylene oxide.

Even more preferred in the dish cleaning and rinsing composition according to the present invention, the surfactant component is based on a combination of at least one surfactant selected from the group consisting of C6 to C18 fatty alcohols propoxylated with 1 to 15 moles propylene oxide in combination with at least one surfactant selected from the group consisting of C6 to C18 fatty alcohols butoxylated with 1 to 10 moles butylene oxide. Further preferred, in the dish cleaning and rinsing composition according to the present invention, the surfactant component is based on a combination of at least one surfactant selected from the group consisting of C6 to C18 fatty alcohols ethoxylated with 1 to 25 moles ethylene oxide; in combination with at least one surfactant selected from the group consisting of C6 to C18 fatty alcohols butoxylated with 1 to 10 moles butylene oxide. Most preferred, in the dish cleaning and rinsing composition according to the present invention, the surfactant component is based on a mixture of C6 to C18 fatty alcohols propoxylated with 1 to 15 moles propylene oxide in combination with at least one surfactant selected from the group consisting of C6 to C18 fatty alcohols ethoxylated with 1 to 25 moles ethylene oxide.

It was found that these specific surfactants in combination with the boosting agents as specified herein provide for improved cleaning properties along with improved rinsing and drying properties in a synergistical manner. This allows for the provision of highly efficient multiphase formulations for use in an automatic dishwasher without the need of providing an additional rinse aid.

### Amphoteric/Zwitterionic Surfactants:

Suitable amphoteric/zwitterionic surfactants for the dish rinsing composition according to the present invention may include any conventional amphoteric/zwitterionic surfactants.

Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the dish rinsing composition according to the present invention, the amphoteric/zwitterionic surfactant is selected from the group consisting of:
C10 to C15 N-(alkyl)-N,N-dimethylamine oxide;
C10 to C15 N-(alkyl)-N,N-bis(2-hydroxyethyl)amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a further preferred variant of the dish rinsing composition according to the present invention, the amphoteric/zwitterionic surfactant is selected from the group consisting of:
C12 to C14 N-(alkyl)-N,N-dimethylamine oxides;
C12 to C14 N-(alkyl)-N,N-bis(2-hydroxyethyl)amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture thereof.

In a most preferred variant of the dish rinsing composition the amphoteric/zwitterionic surfactant is selected from C12 to C14 alkylbetaines, and any mixtures thereof, in particular in view of hand dishwashing compositions.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

The above specified surfactants can be used either singular or in the form of mixtures of two, three, or even more surfactants, either from the same surfactant category (anionic, cationic, non-ionic, amphoteric/zwitterionic) or as mixture of surfactants of different surfactant categories.

Particularly suitable surfactants are non-ionic and/or anionic surfactants (as specified herein) for the purpose of the present invention in view of the dish rinsing composition.

Thus, in the dish rinsing composition according to the present invention, the at least one surfactant is preferably selected from the group consisting of non-ionic surfactant, anionic surfactants, amphoteric/zwitterionic and any mixtures thereof, preferably from the group consisting of non-ionic surfactant, anionic surfactants and mixtures thereof.

Suitable surfactants in view of the dish rinsing composition are for example ethoxylated and/or propoxylated and/or butoxylated nonionic surfactants, and preferably nonionic ethoxylated/propoxylated/butoxylated fatty alcohol surfactants as well as the surfactants and mixtures of surfactants specified in the context of the dish cleaning and rinsing composition.

In the dish rinsing composition according to the present invention, the at least one surfactant is in an alternative variant preferably selected from the group consisting of dodecyl sulfate, dodecyl sulfate ethoxylated with 2 moles ethylene oxide, C10 to C18 sophorolipids, C10 to C18 rhamnolipids, C8 to C14 alkyl polyglycosides, C12 to C14 fatty alcohols ethoxylated with 5 mol ethylene oxide and/or propoxylated with 4 mol propylene oxide, C10 to C14 alkylamidobetaines, or any mixture thereof.

Enzyme or Enzyme Formulation/Component (c), (c1), (c2), (c3)

Optionally the dish cleaning and rinsing compositions according to the present invention can comprise or consist of an additional enzyme component (c) that provides additional cleaning benefits by additionally facilitating the removal of soils from a substrate. Thus, the compositions as specified herein can optionally comprise at least one enzyme or an enzyme formulation, comprising at least one enzyme, as further component (c). The enzyme or enzyme mixture provide for cleaning performance. The addition of at least one enzyme can further boost the cleaning performance while simultaneously allowing for a reduction of the remaining ingredients. Accordingly, preferably the dish cleaning and rinsing composition according to the present invention additionally comprises an enzyme component (c) as specified herein. No enzyme component is required in the dish rinsing compositions (rinse aids) according to the present invention, i.e. usually no enzymes are added in rinse aid products but only to products with both cleaning and rinsing benefits.

Enzymes are known as effective chemicals for use with detergents and other cleaning agents to break down soils. Enzymes break down biochemical soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for dishwashing, laundry, textiles, ware washing, cleaning-in-place, cleaning drains, floors, carpets, medical or dental instruments, meat cutting tools, hard surfaces, personal care, or the like.

Enzymes suitable for the dish cleaning and rinsing compositions, and in particular for combined dish cleaning and rinsing compositions facilitate and speed up the degradation of starch and proteins in the food stains on dishes.

Enzymes that can be used according to the present invention include enzymes that provide desirable activity for removal of protein-based, carbohydrate-based, or triglyceride-based residues; for cleaning, destaining, and sanitizing presoaks, presoaks for flatware, cooking ware, and table ware; or presoaks for meat cutting equipment; for cleaning and destaining food processing surfaces and equipment; and the like.

Suitable enzymes used according to the present invention are selected from the group consisting of proteases, lipases, amylases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, ß-glucanases, arabinosidases, hyaluronidases, chondroitinase, oxidoreductases, and any mixture thereof, preferably the at least one enzyme is selected from the group consisting of protease, lipase, amylase, and any mixtures thereof.

Preferably, the enzyme is either a protease, an amylase, a lipase, or a mixture of a protease, an amylase and a lipase.

Most preferred the enzyme is either a protease, an amylase or a mixture of a protease and an amylase. These enzymes are the most common enzymes used in automatic dishwashing and are the enzymes most suitable for automatic dishwashing in terms of efficacy and stability.

The enzymes used according to the present invention are of any suitable origin, such as vegetable, animal, bacterial, fungal or yeast origin.

Such enzymes include proteases, amylases, lipases, esterases, cellulases, pectinases, lactases and peroxidases as conventionally incorporated into dishwashing compositions.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes and lipase enzymes are particularly advantageous for cleaning soils containing protein, such egg, milk, spinach, meat residue, tomato sauce, or the like. The amylase enzymes are particularly advantageous for removing starch-based soils, such as pasta and rice. The lipase enzymes are particularly advantageous for cleaning soils including fat/grease.

In a variant according to the present invention, the enzyme in the dish cleaning and rinsing composition is a single enzyme. In some other variants, the enzyme in the dish cleaning and rinsing composition is preferably an enzyme cocktail of two, three, four or even more different enzymes. Dishwashing detergents preferably contain two different enzymes (preferably those enzymes are protease and amylase).

Preferably, the at least one enzyme is selected from the group consisting of a protease, an amylase, a lipase, or a mixture thereof.

Proteases: Any protease or mixture of proteases, from any source, can be used in the dish cleaning and rinsing compositions, provided that the selected enzyme is stable in the desired pH range (between about 6 and about 9). For example, the protease enzymes can be derived from a plant, an animal, or a microorganism such as a yeast, a mould, or a bacterium.

Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, and Progress UNO™, Liquanase® and Pristine®, each available from Novozymes; and Preferenz® P and Excellenz® P, each available from DUPONT/IFF.

Lipases: Any lipase or mixture of lipases, from any source, can be used in the dish cleaning and rinsing compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes, and Preferenz® L, available from DUPONT/IFF.

Amylases: Any amylase or mixture of amylases, from any source, can be used in the dish cleaning and rinsing compositions, provided that the selected enzyme is stable in the desired pH range (between about 6 and about 9). For example, the amylase enzymes can be derived from a plant, an animal, or a microorganism such as a yeast, a mould, or a bacterium.

Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Preferably the enzyme used within the scope of the present invention is a mixture of a protease, a lipase and/or an amylase.

Preferred detersive enzymes include a hydrolase such as a protease, an amylase, a lipase, or a combination thereof.

Still more preferred, the enzyme is a protease, an amylase, or a mixture thereof. These enzymes are the most common enzymes used in automatic dishwashing and are the enzymes most suitable for automatic dishwashing in terms of efficacy and stability.

Still more preferred, the enzyme is a protease, a lipase, or a mixture thereof.

Still more preferred, the enzyme is selected from an amylase, a lipase, or a mixture thereof.

In some other embodiments, the enzyme is a protease.

In yet some other variant, the enzyme is an amylase.

In yet some other variant, the enzyme is a lipase.

According to a further preferred variant, the dish cleaning and rinsing composition according to the present invention further additionally comprises or consists of a combination of two different enzymes, preferably selected from the group consisting of proteases, lipases and amylases. Even mor preferred, said two enzymes are selected from the group of proteases and amylases.

Preferred enzymes in solid dish cleaning compositions according to the present invention for food processing surfaces and equipment include a protease, a lipase, an amylase, a gluconase, or a combination thereof, preferably a protease, a lipase, an amylase, or a combination thereof.

Preferred enzymes in solid dish cleaning compositions according to the present invention for meat cutting tools include a protease, a lipase, or a combination thereof.

Commercial enzymes are obtainable in liquid or dried form (i.e. puck, powder, etc.), are sold as raw aqueous solutions or in assorted purified, processed and compounded forms established in the prior art, and include about 0.1% to about 80% by weight active enzyme generally in combination with stabilizers, buffers, cofactors, impurities and inert vehicles. The actual active enzyme content depends upon the method of manufacture and is not critical; assuming the solid dish cleaning composition has the desired enzymatic activity.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches, or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers, and are storage-stable on account of the coating.

Furthermore, it is possible to package two or more enzymes together so that a single granulate exhibits multiple enzyme activities.

Preferably, the enzyme(s) are added to the respective compositions either as single enzyme formulation, or as enzyme cocktail formulation comprising a mixture of different enzymes.

In a preferred variant according to the present invention, the enzyme (c) is added to the dish cleaning and rinsing composition as a single enzyme.

In some other variants, the enzyme (c) added to the dish cleaning and rinsing composition is preferably an enzyme cocktail of two, three, four or even more different enzymes.

Still more preferred the at least one enzyme is added to the respective compositions according to the present invention as enzyme formulation in admixture with one or more enzyme stabilizers, preferably with one or more commonly used enzyme stabilizers (enzyme stabilizing agent(s)), and optionally buffers, additives, and the like.

The enzyme is present in the dish cleaning and rinsing composition according to the present invention in an amount of 0.00001% to 5% by weight, based on the total weight of the composition. Preferably, the enzyme is present in an amount of 0.0001% to 4% by weight, based on the total weight of the composition. More preferred the dish cleaning and rinsing composition according to the present invention comprises the enzyme in an amount of 0.001% to 3% by weight, based on the total weight of the composition. Most preferred the enzyme is present in the dish cleaning and rinsing composition in an amount of 0.01% to 2% by weight, based on the total weight of the composition.

For an enzyme cocktail the above amounts relate to the total content of the enzymes in the mixture, i.e. the amount is the sum of the content of all enzymes in the mixture.

The cleaning and/or rinsing composition according to the present invention optionally also comprises at least one further enzyme stabilizer (or enzyme stabilizing agent) to stabilize the enzyme in the composition from loss of activity (i.e. retain proteolytic activity or enzymatic retention). The formulation of the dish cleaning and/or rinsing compositions may vary based upon the particular enzymes employed.

Thus, according to a further preferred embodiment, the dish cleaning and rinsing compositions according to the present invention, further comprise or consist of at least one enzyme stabilizing agent.

Suitable enzyme stabilizers or enzyme stabilizing agents are for example selected from the group consisting of polyols such as glycol, such as monopropylene glycol, glycerine, mannitol, isomaltol, lactic, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

The enzyme formulation with the enzyme stabilizer is added to the dish cleaning and rinsing compositions in such amounts, that the enzyme stabilizer is present in the dish cleaning and rinsing compositions in an amount of 0.0001% to 5% by weight, based on the total weight of the dish cleaning and rinsing compositions. Preferably, the enzyme stabilizer is present in an amount of 0.001% to 4% by weight, based on the total weight of the dish cleaning and rinsing compositions. Most preferred, the dish cleaning and rinsing compositions include the enzyme stabilizer in an amount of 0.01% to 3% by weight, based on the total weight of the composition.

Alternatively, and still more preferred, the at least one enzyme (c) is added to the dish cleaning and rinsing composition according to the present invention as enzyme formulation in mixture with 1,2-heptanediol and/or 2,3-heptanediol or a specific type of boosting agents (a), such as alkanediols, glyceryl caprylate, 4-hydroxyacetophenone, ethyl hexyl glycerin or tropolone, and optionally buffers, additives, and the like.

In a further preferred variant, the at least one enzyme (c) is added to the dish cleaning and rinsing composition according to the present invention as enzyme formulation in mixture with an enzyme stabilizer and with 1,2-heptanediol and/or 2,3-heptanediol or a specific type of boosting agents (a), such as alkanediols, glyceryl caprylate, 4-hydroxyacetophenone, ethyl hexyl glycerin or tropolone, and optionally buffers, and the like.

For the dish cleaning and rinsing composition according to the present invention, the list of the boosting agents (a1, a2, a3, a) specified herein can be arbitrary combined with the list of the enzymes (c) and/or surfactants (b) as specified herein.

### Optional Further Components

Within the context of the present invention, it is also possible, and in some cases advantageous, to combine the dish cleaning and/or rinsing composition according to the present invention with other active substances and/or additives, depending on the purpose of the composition, in order to obtain a ready-for-use composition or formulation. The active ingredients provide desired properties and functionalities to the dish cleaning and/or rinsing compositions according to the present invention. The term “functional ingredient” or “functional additive” includes an ingredient that provides a beneficial property in a particular use. Some particular examples of functional ingredients are discussed in more detail below, and that a broad variety of other functional ingredients may also be used.

The dish cleaning and/or rinsing compositions according to the present invention may comprise any of the ingredients customarily found in such compositions, such as, for example organic solvents, builders, and additional auxiliaries such as soil repellents, thickeners, colorants and fragrances or the like.

Preferably, the dish cleaning and/or rinsing composition according to the present invention, further comprises or consists of at least one active substance and/or at least one (functional) additive selected from the group consisting of: dyes/coloring agents, odor removal/odor capturing agents, soil shielding/soil releasing agents, soil-suspending agents, anti-redeposition agents, ultraviolet light protection agents, fragrances, sanitizing agents, antimicrobial agents and disinfecting agents (such as benzoic acid or salicylic acid), water repellency agents, souring agents, mildew removing agents, solubility modifiers and solubilizers (such as triethanolamine and solvents), rheology modifiers or thickeners, dispersing agents, water softeners and/or softener salts and/or chelating agents and/or other complexing agents which are added to reduce the hardness of water (such as citrates, zeolites, polycarboxylates, aspartic acid and polyaspartates (for example, tetrasodium iminodisuccinate), tetrasodium etidronate, salts of etidronic acid, phosphates), buffers (such as carboxylic acids, in particular citric acid or its salts), solvents, defoamers/foam inhibitors/suds suppressors, foam stabilizers, bleaching agents, bleach activators, bleach catalysts and/or bleach stabilizers, bleach scavengers, anti-tarnish agents, anti-scalants/anti-scaling agents, anti-corrosion agents/corrosion inhibitors, sequestrant agents (sequestrants), builders, co-builders, salts, binders/fillers, pH-adjusters, stabilizers, hydrotropes, flow control agents, preservatives, detergents and/or other wash-active substances, inorganic salts, and any mixtures thereof.

### Anti-Spotting and Anti-Tarnishing Agents/Compositions:

The dish cleaning and/or dish rinsing composition according to the present invention, can further comprise or consist of at least one additional anti-spotting agent or anti-spotting composition. Useful anti-spotting agents include Mirapol® Surf-S 480 PF (1,2-benzisothiazol-3(2H)-one,2-methyl-2H-isothiazol-3-one), polyacrylic acid polymers and salts thereof. Other suitable substances are known in the art.

Further suitable additives are so-called anti-tarnishing agents such as benzotriazole or those described in EP 0 723 577 A1.

Alternative anti-spotting rinse aids are for example disclosed in U.S. Pat. No. 6,239,091 and EP 1 721 962 B1. Further suitable dishwashing rinse aid formulations are those disclosed in EP 2 622 054 B1, and which are based on cationic polysaccharides.

### Anti-Scaling Agents, Water Softeners, Sequestrants/Chelating Agents and Other Complexing Agents:

The dish cleaning and/or rinsing composition according to the present invention, can further optionally comprise so-called anti-scaling agents (also referred to as scale prevention agents or scale inhibitors or anti-scalants) to minimize the formation of scale. Those substances are known by the person skilled in the art and include amongst others polyacrylates of molecular weight from 1 000 to 400 000 or other polymers based on acrylic acid. Therese are usually chelating agents.

Such anti-scaling agents can be added in amounts of 0.2% to 10% by weight of the total composition and preferably in amounts of 0.5% to 5% by weight of the total composition.

Furthermore, the compositions disclosed herein can also optionally contain one or more chelating agents, capable of complexing iron, manganese and/or calcium ions. This additionally allows for a softening of water.

If utilized, these chelating agents will generally be comprised from about 0.1% to about 10% by weight of the total compositions herein. More preferably, if utilized, the chelating agents will comprise from about 0.1% to about 3.0% by weight of such compositions.

Chelating agents can be present in the acid or salt form including alkali metal, ammonium, and substituted ammonium salts thereof, and mixtures thereof.

Preferably the chelating agent is selected from the group consisting of amino carboxylates, phosphonates or mixtures thereof.

These agents as used herein include those chemicals which interact with divalent ions, cations and anions, having tendency to precipitate in their saturated aqueous solutions.

Suitable anti-scaling agents, water softeners, sequestrants/chelating agents are for example:

Useful amino carboxylate chelating agents include, but are not limited to, the following: N-(1,2-dicarboxy-ethyl)-D,L-aspartic acid (IDS), N-(2-hydroxyethyl)iminodiacetic acid (EDG), aspartic acid-N-monoacetic acid (ASMA), aspartic acid-N,N-diacetic acid (ASDA), aspartic acid-N-mono-propionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (AND A), sulfanilic acid-N,N-diacetic acid (SLDA), taurine-N,N-diacetic acid (TUDA), sulfomethyl-N,N-diacetic acid (SMDA), N-(hydroxyethyl)-ethylidenediaminetriacetate (HEDTA), diethanolglycine (DEG), aminotris(methylenephosphonic acid) (ATMP).

The preferred chelating agent may contain an amino group and may be, e.g., an amino-polycarboxylate or a phosphonate. It may be a monomeric molecule comprising one, two or three amino groups (typically secondary or tertiary amino groups), and it may contain two, three, four or five carboxyl groups or even more carboxyl groups. The chelating agents may be phosphorus containing or without phosphorus. Suitable chelating agents include those based on carboxylate groups and amongst others include EDTA (ethylene diamine tetraacetate), NTA (2,2′,2″-nitrilotriacetate), citrate, 2-hydroxypropan-1,2,3-tricarboxylate, DTPA (diethylenetriaminepentaacetic acid), MGDA (methylglycinediacetic acid OT N,N′-bis(carboxymethyl)alanine), EGTA (ethylene glycol tetraacetic acid), EDDS (ethylenediamine-N,W-disuccinic acid), GLDA (L-Glutamic acid, N, N-diacetic acid), The composition preferably may also include other polycarboxylates such as PAA [poly(acrylic acid)], PAA/PMA [copoly(acrylic acid/maleic acid)], or mixtures thereof.

Another group of preferred chelating agents includes phosphonates. Aminoalkane and/or hydroxyalkane phosphonates are preferably used as phosphonates. Suitable examples of these phosphonate chelating agent include HEDP (1-hydroxyethylidene-1,1-diphosphonic acid), EDTMP [ethylenediamine tetra(methylene phosphonic acid], EDTMPA (ethylenediaminetetramethylene-tetraphosphonic acid), DTPMP (diethylenetriamine penta (methylene phosphonic acid), DTMPA (diethylenetriaminepenta(methylenephosphonic acid)) nitrilotris(methylenephosphonic acid) (NTMP), 2-phosphonobutane-1,2,4-tricarboxylic acid (PBTC), ethylenediamine tetramethylene phosphonate (EDTMP), and the higher homologs thereof. Among the hydroxyalkane phosphonates, 1-hydroxyethane-1,1-diphosphonate (HEDP) is of particular importance. The chelating agents may contain nitrogen such as in EDTA, NTA, DTPA, PDTA, GLDA, MGDA, EDDS, EDTMP, EDTMPA, and DTPMP or ASMA, ASDA, ASMP, IDA, SMAS, SEAS, SMGL, SEGL, MIDA, a-ALDA, SEDA, ISDA, PHDA, ANDA, SLDA, TUDA, SMDA, HEDTA, DEG, ATMP, or mixtures thereof.

Particularly preferred chelating agents include but are not limited to the following: ethylene-diamine-tetra-acetic acid (EDTA), diethylene triamine pentamethylene phosphonic acid (DTMPA, DTPMP), hydroxy-ethane diphosphonic acid (HEDP), ethylenediamine N,N-disuccinic acid (EDDS), methyl glycine di-acetic acid (MGDA), diethylene triamine penta acetic acid (DTPA), propylene diamine tetraacetic acid (PDTA), 2-hydroxypyridine-N-oxide (HPNO), methyl glycine diacetic acid (MGDA), glutamic acid N,N-diacetic acid (N,N-dicarboxymethyl glutamic acid tetrasodium salt (GLDA) and nitrilotriacetic acid (NTA) or mixtures thereof. The chelating agent may be present in their acid form or a salt, preferably the chelating agents may be present as a sodium, ammonium, or potassium salt.

Especially preferred chelating agent include diethylenetriamine pentacetic acid (DTPA), ethylenediamine-N,N′-disuccinic acid (EDDS) and 1,1-hydroxyethane diphosphonic acid (HEDP) or the alkali metal, potassium, alkaline earth metal, ammonium or substituted ammonium salts thereof, or mixtures thereof. The most preferred chelating agent is a phosphonate. The phosphonate chelating agent includes HEDP in its acid form or salt form with alkali metal, potassium, alkaline earth metal, ammonium or substituted ammonium.

Most preferred are the following chelating agents: GLDA, MGDA, citrate, HEDP, and any mixture thereof.

In the composition according to the present invention, the chelating agent is typically present in an amount from 0.1% by weight to 10% by weight, still preferably from 0.1% by weight to 5% by weight, preferably from 0.1% by weight to 3% by weight, and more preferably from 0.1% by weight to 1% by weight based on the total weight of the composition or product.

Preferably the composition comprises at least 0.2% by weight chelating agent based on the weight of the composition, still preferably at least 0.3% by weight, still preferably at least 0.5% by weight, most preferably at least 0.6% by weight based on the total weight of the composition or product.

In some automatic dishwashing gels, the amount of GLDA can be from 30% to 40% by weight based on the weight of the composition.

Preferably the dish cleaning and/or rinsing compositions according to the present invention further comprise at least one chelating agent. It was further found that the combination of surfactants (preferably anionic and/or non-ionic surfactants), boosting agents as defined herein and chelating agents result in a further improvement of the rinsing properties in terms of anti-spotting and thus the drying performance, especially when incorporated into automatic dishwashing formulations.

In this context particularly preferred are the following chelating agents selected from the group consisting of GLDA, MGDA, citrate, HEDP and any mixtures thereof.

### Corrosion Inhibitors:

The compositions according to the present invention can further comprise corrosion inhibiters to protect the dishwasher itself as well as to reduce the tarnishing of silver flatware.

Typical corrosion inhibitors or anti-corrosion agents are for example benzotriazole and other members of the azole family such as imidazoles, bismuth compounds such as bismuth nitrate, heavy metal salts of copper, iron, manganese, zinc, or titanium, paraffin oil, non-paraffin oil organic agents such as fatty esters of mono or polyhydric alcohols.

A typical agents used against glass corrosion is for example zinc sulphate.

Further suitable substances are known in the art.

Dish Cleaning and/or Dish Rinsing Products

According to a further aspect of the present invention, the dish cleaning and rinsing composition according to the present invention is used as such, or for the preparation of a multifunctional dish cleaning and rinsing product.

According to another aspect of the present invention, the dish rinsing composition according to the present invention is used as such, or for the preparation of a rinsing product such as a rinse aid.

Preferably, both the dish cleaning and rinsing compositions as well as the dish rinsing compositions according to the present invention are used as, or alternatively incorporated into a dish cleaning and rinsing formulation or into a rinsing formulation.

Even more preferred compositions according to the present invention are used as anti-spotting agent/composition.

The combination of surfactants and boosting agents such as alkanediols, glyceryl caprylate, 4-hydroxyacetophenone, ethyl hexyl glycerin, and/or tropolone provides for enhanced cleaning performances. In particular, however, the drying performance is optimized. Based in the specified combinations as specified herein deposits can efficiently be reduced and spotting on dishes caused by water deposits upon drying can efficiently be suppressed.

Thus, the compositions according to the present invention are efficient anti-spotting agents.

These advantages are particularly useful in the automatic dishwashing process and allow for an improved rinsing/drying performance with improved appearance and finishing results. Thus, the compositions according to the present invention are particularly suitable dishwasher detergents and/or rinsing aids.

Surprisingly it was found, that also the alkanediols disclosed herein as such are excellent anti-spotting agents.

Based on their advantageous anti-spotting effect along with the boosting effects in connection with the surfactant component, the present invention relates in a further aspect to the use of 1,2-heptanediol or 2,3-heptanediol or a mixture comprising 1,2-heptanediol and 2,3-heptanediol or at least one boosting agent (a) selected from the group consisting of:
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
(a^{II}) glyceryl caprylate;
(a^{III}) 4-hydroxyacetophenone;
(a^{IV}) ethyl hexyl glycerin;
(a^{V}) tropolone; and
any mixture thereof;
for reducing deposits and/or spotting on dishes and/or as anti-spotting agent.

According to a further aspect the present invention relates to the use of 1,2-heptanediol or 2,3-heptanediol or a mixture comprising 1,2-heptanediol and 2,3-heptanediol or at least one boosting agent (a) selected from the group consisting of:
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
(a^{II}) glyceryl caprylate;
(a^{III}) 4-hydroxyacetophenone;
(a^{IV}) ethyl hexyl glycerin;
(a^{V}) tropolone; and
any mixture thereof; and
(b) at least one surfactant;
for reducing deposits and/or water spotting on dishes and/or as anti-spotting agent and/or as rinse aid.

Preferably, the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations of these ethoxylated, butoxylated and propoxylated fatty alcohols.

Because of the boosting effect, the amount of surfactants and further additives such as rinse aids in a dishwashing composition can be reduced while providing for a highly efficient reduction of deposits and/or spotting on dishes. As a result, the dish cleaning and/or rinsing compositions according to the present invention are more effective compared to corresponding compositions without the addition of an inventive boosting agent or mixture of boosting agents in terms of cleaning performances and rinsing/drying properties and anti-spotting.

It was surprisingly found that the use of 1,2-heptanediol or 2,3-heptanediol or a mixture comprising 1,2-heptanediol and 2,3-heptanediol or at least one boosting agent (a) as specified herein boost the cleaning power of surfactants and simultaneously improve the drying performance. The use of the afore-mentioned substances allows for the efficient reduction of deposits, filing and water spotting on the surfaces of washed items. This superior effect is based on the synergistic activity of the surfactant component (b) and the boosting component (a) resulting in a superior performance which allows for the reduction of the overall surfactant and ingredient amount in common dishwashing and/or rinsing formulations.

Furthermore, surprisingly 1,2-heptanediol or 2,3-heptanediol or a mixture comprising 1,2-heptanediol and 2,3-heptanediol or at least one boosting agent (a) as specified herein can be used as anti-spotting agent and thus instead of commercially available rinse aids or drying aids based on the their highly efficient anti-spotting and anti-filming properties along with their superior drying performance thereby providing for an improved appearance after washing and/or drying and in particular during the automatic dishwashing process.

Furthermore, it was found that the specific combination of ingredients efficiently contributes to prevent a redeposition of soils and thus the formation of deposits on the washed items.

Furthermore, surprisingly 1,2-heptanediol or 2,3-heptanediol or a mixture comprising 1,2-heptanediol and 2,3-heptanediol or at least one boosting agent (a) as specified herein can be used as rinsing agent and/or as anti-spotting agent as such.

The compositions disclosed herein are suitable additives for the formulation of dish cleaning and/or dish rinsing products, in particular combined automatic dishwasher products, i.e. products combining cleaning and rinsing aspects. However, it was additionally found that the compositions disclosed herein as such are suitable as dish cleaning and/or dish rinsing products.

Thus, in a further aspect the present invention relates to the use of the dish cleaning and/or rinsing composition according to the present invention either as, or, for the preparation of a dish cleaning and/or dish rinsing product (preferably a combined cleaning and rinsing product or a rinsing product such as a rinse aid).

Thus, the present invention further relates to dish cleaning and/or dish rinsing products comprising or consisting of the dish cleaning and/or rinsing compositions according to the present invention, preferably wherein the product is an automatic dishwashing product, and further preferred combined cleaning and rinsing product or a rinsing product.

The dish cleaning and/or rinsing compositions according to the present invention may be integrated into a commercially available product formulation or they may be used as a separate product as such, i.e. as dishwasher detergents and/or a rinse aids, preferably used for automatic dishwashing, meaning that also combined products can be provided (multi-purpose products with rinse aid function). Such products are advantageously used in automatic dishwashing where no separate rinsing step using a separate rinsing product is applied.

The compositions according to the present invention demonstrate good anti-spotting/shine properties on articles treated therewith.

Thus, these products may be, for example, dishwashing detergents and/or rinse aids used for automatic dishwashing. Preferably however, the product is an automatic dishwasher product and more specifically for household machines. The product can either be used as combined multi-purpose cleaning product (dishwashing detergent) with rinse aid function or alternatively as rinse aid as such.

The dish cleaning and/or rinsing compositions or products as specified herein can be employed in a variety of cleaning methods determined.

In a preferred embodiment the dish cleaning and/or rinsing product is preferably selected from the group consisting of detergents such as dishwashing detergents, rinsing products such as rinse aids, combined multiphase products, and mixtures thereof, each of the aforementioned in liquid, granule, encapsulated, flake, pellet, bead, powder, bar, paste, spray, tablet, gel, or foam, or mousse form or another solid or liquid form known to those skill in the art, and optionally in two-compartment or multi-compartment form, i.e. the composition of the invention can be formulated into various forms. The composition of the present invention is advantageously a 2-in-1-detergent composition having both cleaning and anti-spotting and/or anti-filming effects and is preferably designed for the use in an automatic dishwasher.

The afore-mentioned refers to a dish cleaning and/or rinsing composition in the form of a liquid or a solid, or gelled, pasty, encapsulated, diluted or concentrated form.

If applied as pure rinsing agent, the composition is preferably provided in liquid form.

As used herein, liquid includes free-flowing liquids, as well as pastes, gels, foams and mousses. Non-limiting examples of liquids include liquid dishwashing detergent and rinse aids commonly used. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art. Solid formulations are particularly advantageous for use in automatic dishwashing.

The composition according to the present invention can either be used in diluted or concentrated form.

The compositions according to the present invention can either be used as such or incorporated into dish cleaning and/or rinsing formulations.

A solid dish cleaning and/or rinsing composition or product can be provided as a pressed solid block, a cast solid block, an extruded pellet or block, or a tablet. Furthermore, a solid dish cleaning and/or rinsing composition or product may be provided in the form of a unit dose. A unit dose refers to a solid dish cleaning and/or rinsing composition unit sized so that the entire unit is used during a single washing cycle.

The cleaning and/or rinsing composition can be provided as part of a multi-phase unit dose composition, preferably stepwise releasing the active ingredients, and being consumed in a single washing operation. For this purpose, the composition can be at least partially enveloped by a water-soluble or water dispersible package. Optionally a water-soluble package is provided in the form of a multi-compartment package with each compartment containing one or more detergent compositions and/or different actives. Products in unit dose form include tablets, capsules, sachets, pouches, etc. and can be provided in the form of a unit dose.

Alternatively, the compositions disclosed herein, in particular in view of the improved rinsing benefits, can be applied as so-called “carry over” compositions, i.e. compositions which are “carried over” through the individual cleaning and rinsing processes in a dishwasher during the course of the cleaning and rinsing process.

A solid dish cleaning and/or rinsing composition or product may also be provided in the form of a multiple use (e.g., multi-use) solid, such as, a block or a plurality of pellets, and can be repeatedly used to generate aqueous use solutions of the dish cleaning and/or rinsing composition for multiple cycles or a predetermined number of dispensing cycles. A multiple use solid dish cleaning and/or rinsing composition can be repeatedly used to generate an aqueous dish cleaning and/or rinsing composition, e.g., use solution, for multiple washing cycles. Pressed solid dish cleaning and/or rinsing blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid dish cleaning and/or rinsing blocks are made by using a binding system to minimize any damage to the coated granules which may be employed. Beneficially, a pressing process to make the pressed solid dish cleaning and/or rinsing blocks generates a pressed solid dish cleaning and/or rinsing block and prevents the reaction or mix of the components. In an aspect of the disclosure, the solid dish cleaning and/or rinsing composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mould or container). The method can include gently pressing the flowable solid in the form to produce the solid cleaning composition.

The dish cleaning and/or rinsing compositions or products can be provided in concentrated form and diluted to a use solution or provided in a use solution. When used as rinsing agent and/or as anti-spotting agent as such the compositions are preferably used in concentrated form.

The dish cleaning and/or rinsing compositions or products can be prepared by combining and mixing the various ingredients according to usual and known methods. Mixing can be performed by any suitable automatic or manual method. For example, automatic or manual stirring can be performed. The dish cleaning and/or rinsing compositions can be prepared in batch or continuous process.

However, it was further found that long-chain alkanediols as such are likewise suitable for use as anti-spotting agents, providing for an efficient reduction and/or prevention of the formation of deposits and/or water spotting on dish ware.

Thus, another object of the present invention refers to the use of 1,2-heptanediol or 2,3-heptanediol or a mixture comprising 1,2-heptanediol and 2,3-heptanediol or at least one boosting agent (a) selected from the group consisting of at least one linear alkanediol having a carbon chain of 10 to 14 carbon atoms or a mixture comprising at least one first linear alkanediol having a carbon chain of 10 to 14 carbon atoms and one or more second linear alkanediols having a carbon chain of 10 to 14 carbon atoms which is different from the first linear alkanediol as defined herein for reducing deposits and/or spotting on dishes and/or as anti-spotting agent.

Method of Reducing Deposits and/or Water Spotting on Dishes

Additionally, a method of reducing deposits and/or water spotting on dishes is provided herein.

Thus, another object of the present invention refers to a method of reducing deposits and/or water spotting on dishes, comprising the steps of:
(i) providing a dish cleaning and/or rinsing composition, comprising or consisting of at least one surfactant, such as a standard dish washing composition and/or rinsing composition; and
(ii) adding thereto an effective amount of 1,2-heptanediol or 2,3-heptanediol or a mixture comprising 1,2-heptanediol and 2,3-heptanediol or at least one boosting agent (a) selected from the group consisting of:
   (a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined herein;
   (a^{II}) glyceryl caprylate;
   (a^{III}) 4-hydroxyacetophenone;
   (a^{IV}) ethyl hexyl glycerin;
   (a^{V}) tropolone; and
   any mixture thereof.

During the washing step and/or the rinsing step the items to be washed are contacted with the compositions according to the present invention. Subsequently, the treated items are subject to drying. Both steps are executed subsequently in an automatic dishwasher.

It was surprisingly discovered that adding an alkanediol/boosting agent or a mixture of boosting agents as specified above can boost the cleaning performance and/or the rinsing/drying performance in a dish cleaning and/or rinsing composition by simultaneously considerably reducing the formation of water spots which are caused by minerals such as limestone or chalk left behind as water evaporates off a surface (improved drying/rinsing/anti-spotting performance).

In this context it has been found that the addition of an effective amount of 1,2-heptanediol or 2,3-heptanediol or a mixture comprising 1,2-heptanediol and 2,3-heptanediol or a specific type of boosting agents, such as alkanediols, glyceryl caprylate, 4-hydroxyacetophenone, ethyl hexyl glycerin and/or tropolone, as defined herein, to a dish cleaning and/or rinsing composition efficiently improve the cleaning performance and/or the rinsing/drying performance while simultaneously reducing water-spotting. Particularly preferred is their use in combined dish washing and rinsing compositions as well as in rinsing compositions comprising a surfactant component.

Hence, the use or addition of one of the afore-mentioned substances to a dish cleaning and/or rinsing compositions allows for the efficient reduction of deposits on dishes and/or for their use as efficient rinsing agents or as anti-spotting agent.

However, it was further found that these substances as such are excellent anti-spotting agents.

1,2-Heptanediol or 2,3-heptanediol or a mixture comprising 1,2-heptanediol and 2,3-heptanediol or a specific type of boosting agents, such as alkanediols, glyceryl caprylate, 4-hydroxyacetophenone, ethyl hexyl glycerin or tropolone, as defined herein, can advantageously be used for reducing deposits and water spotting and/or as anti-spotting agents.

It was surprisingly found that 1,2-heptanediol or 2,3-heptanediol or a mixture comprising 1,2-heptanediol and 2,3-heptanediol or a specific type of boosting agents, such as alkanediols, glyceryl caprylate, 4-hydroxyacetophenone, ethyl hexyl glycerin and/or tropolone, as defined herein have excellent anti-spotting properties and/or can boost the anti-spotting effect provided by the surfactant components such as for example non-ionic surfactants.

It was additionally found that the hydrophobic (water repellent) properties of the boosting agents according to the present invention are particularly advantageous in achieving an improved drying/anti-spotting. Thus, longer chained substances, i.e. more hydrophobic substances are particularly preferred in order to achieve better anti-spotting results.

According to an alternative embodiment it was found that also short-chain alkanediols as well as combinations of short-chain and long-chain alkanediols are efficient anti-spotting agents.

The combination of alkanediols/boosting agents with surfactants contributes to a more effective cleaning and drying process and results in improved finishing performances with better shine, reduced/prevented filming, deposits and spotting on the washed items in a synergistical manner.

Thus, based on the combined effect of efficiently cleaning (reduction of deposits) and the improved rinsing/drying properties (improved drying performance with reduction of water spotting, improved finishing properties) the compositions according to the present invention are highly suitable “all-in-one” dish cleaning and rinsing compositions, in particular for use in an automatic dishwasher, thereby allowing for a significant reduction in chemicals and products.

The present invention shall now be described in detail with reference to the following examples, which are merely illustrative of the present invention, such that the content of the present invention is not limited by or to the following examples.

### Examples

The synergistic improvement of the rinsing performance (finishing performance) was analyzed according to the standard developed by the Nordic Swan Ecolabel, the official ecolabel of the Nordic countries as well as based on a visual evaluation.

For this purpose, parity or better is achieved on at least 6 of the 8 criteria (spotting and filming across at least four different kind of objects that are tested). A statistical treatment with 95% confidence must be performed as required by the test.

The test design is as follows (Dishwasher detergents and rinse aids, Criteria document—version 7.1, pages 30 f.):

Water hardness: At least 9° dH for classic products (with or without rinse aid function). At least 18° dH for multifunctional products (with rinse aid and salt function). The water hardness shall be the same for the test and reference product.
Wash temperature: 50° C., rinsing temperature: 65° C.
Dosage:
   Reference: Rinse aid formula III: 3 ml. In addition, 20 grams of IEC-D reference detergent must be used.
   If test product is a rinse aid liquid: 3 ml test product. In addition, 20 grams of IEC-D reference detergent must be used.
   If test product is a classic 2-in-1 product (with rinse aid function): One standard dose as recommended at 6° dH.
   If test product is a multifunctional product with rinse aid function: One standard dose as recommended at 18° dH.
50 grams of ballast soil must be used in each wash cycle. The ballast soil must be based on starch, protein and fat. Additionally, other constituents from food ingredients may also be present.
The commercial ion exchanger must be disabled.
At least 3 wash cycles must be carried out, cumulative, before assessment.
The products must be assessed on spotting and filming across at least 4 different kinds of objects including objects made of plastic, glass, ceramic/porcelain and stainless steel.

Criteria for the visual assessment of the anti-spotting power were for example the shine maintenance and dullness prevention, the degree and amount of water deposits/spotting on glassware, and the degree and amount of streaks and filming on glassware. Different materials, relevant to consumer daily use, were washed in a dishwasher using the compositions according to the present invention as combined wash and rinse products and alternatively as rinse aids in comparison to standard dishwashing detergents and/or rinse aids and those not comprising the inventive anti-spotting agents. Those materials are visually assessed under spotlights to detect major and minor defaults and to determine the level of filming and spotting build up, on a scale.

It was surprisingly observed that the compositions according to the present invention show improved rinsing properties. Based on the superior rinsing performances showing a considerably reduced spotting and filming the compositions according to the present invention are highly suitable rinse aids themselves.

The formulations according to the present invention were added to standard and commercially available machine dishwashing detergent formulations. After treating with different stains, the glass ware was washed in an automatic dishwasher with a normal wash program. After completion of the wash and drying program, the appearance of the washed glassware was assessed visually. Washed glasses were scored using a scale from 0 to 5 in which 0 is completely covered with spots or heavy chalky film and 5 is clear. The same scale was used to assess the cleaning performance as such in terms of stain removal.

In a further example, water sheeting of hydrophobic surface like plastic surface was analyzed.

In order to analyze the pure spotting performance further simple test were performed, where water is sprayed on the glass or plastic surfaces and the behavior of the droplets was visually observed. After drying at room temperature or after applying heat the spotting was assessed visually by a panel.

These examples clearly demonstrate the ability of the dish cleaning and rinsing compositions according to the present invention to efficiently clean the items and simultaneously to provide for excellent finishing properties. Thereby, it was observed that the effect was considerably improved when using the compositions according to the present invention compared to the surfactants and hydroxyl compounds alone.

Also the dish rinsing compositions according to the present invention were efficient in preventing the formation of filming or spotting on a broad variety of different materials and surfaces.

Additionally, similar experiments were performed in order to show the anti-spotting and cleaning properties of the present invention.

### Formulation Examples

TABLE F1
Dishwashing detergent (ADW—Auto Dish Washing gel)
- 2-in-1 product (dish washing and rinsing formulation)

| No. | Ingredient | Amount (%) |
|---|---|---|
| 1 | Water | add 100 |
| 2 | Glutamic acid, N,N-diacetic acid, tetrasodium salt | 17 |
| 3 | Glycerin | 15 |
| 4 | Citric acid | 3 |
| 5 | Acrylic copolymer | 2 |
| 6 | Fatty alcohol alkoxylated *⁾ | 1 |
| 7 | Sodium cumenesulfonate | 1 |
| 8 | Xanthan Gum | 0.5 |
| 9 | 1,2-Heptanediol | 1.2 |
| 10 | Protease (Subtilisin) | 1.5 |
| 11 | Amylase | 0.5 |

*⁾ propoxylated, butoxylated, and combination of ethoxylated/propoxylated and ethoxylated/butoxylated

TABLE F2
Automatic Dishwashing tablet - 2-in-1 product
(dish washing and rinsing formulation)

| No | Ingredients | Amount (%) |
|---|---|---|
| 1 | Sodium carbonate | add to 100 |
| 2 | Sodium citrate | 15 |
| 3 | MGDA | 15 |
| 4 | Sodium percarbonate (Sodium carbonate peroxide) | 13 |
| 5 | Fatty alcohol polyglycol ether | 4 |
| 6 | Polyacrylate sulphonated copolymer | 4 |
| 7 | Polyethylene glycol (MW 400 - MW 8000) | 3 |
| 8 | Sodium sulphate | 5 |
| 9 | Sodium silicate | 5 |
| 10 | Zeolite | 4 |
| 11 | TAED | 2 |
| 12 | Cellulose | 1 |
| 13 | Tetrasodium Etidronate | 2 |
| 18 | 1,2-heptanediol | 0.9 |
| 19 | Fragrance | 0.4 |
| 20 | Mn-TACN | 0.04 |
| 21 | Protease | 1.7 |
| 22 | Amylase | 0.7 |
| 23 | Benzotriazole | 0.3 |

TABLE F3
Liquid rinse aid

| No | Ingredients | Amount (%) |
|---|---|---|
| 1 | Aqua - water | QSP 100% |
| 2 | Fatty alcohol alkoxylated | 10 |
| 3 | 1,2-Octanediol | 1 |
| 4 | Sodium cumene sulfonate | 5 |
| 5 | Citric acid | 5 |
| 6 | CMIT/MIT (Methylchloroisothiazolinone/ | 0.0015 |
| | Methylisothiazolinone) | |

TABLE F4
Dishwashing detergent (ADW—Auto Dish Washing gel)
- 2-in-1 product (dish washing and rinsing formulation)

| No. | Ingredient | Amount (%) |
|---|---|---|
| 1 | Water | add 100 |
| 2 | Glutamic acid, N,N-diacetic acid, tetrasodium salt | 17 |
| 3 | Glycerin | 15 |
| 4 | Citric acid | 3 |
| 5 | Acrylic copolymer | 2 |
| 6 | Fatty alcohol alkoxylated *⁾ | 1 |
| 7 | Sodium cumenesulfonate | 1 |
| 8 | Xanthan Gum | 0.5 |
| 9 | 1,2-Heptanediol | 1.2 |
| 10 | Protease (Subtilisin) | 1.5 |
| 11 | Amylase | 0.5 |

*⁾ C12-C14, ethoxylated with 5 moles ethylene oxide and propoxylated with 4 moles propylene oxide

1. A dish cleaning and rinsing composition for automatic dish washing, comprising or consisting of
(a) at least one boosting agent selected from the group consisting of
(a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
(a^{II}) glyceryl caprylate;
(a^{III}) 4-hydroxyacetophenone;
(a^{IV}) ethyl hexyl glycerin;
(a^{V}) tropolone; and
any mixtures thereof; and
(b) at least one surfactant, wherein the at least one surfactant is a non-ionic surfactant selected from the group consisting of C6 to C18 fatty alcohols propoxylated with 1 to 15 moles propylene oxide, C6 to C18 fatty alcohols ethoxylated with 1 to 25 moles ethylene oxide, C6 to C18 fatty alcohols butoxylated with 1 to 10 moles butylene oxide, and any combinations thereof; and
(c) optionally or preferably at least one enzyme or an enzyme formulation, comprising at least one enzyme.

2. A dish rinsing composition, comprising or consisting of
(a) at least one boosting agent selected from the group consisting of
(a^{I}) at least one linear alkanediol having a carbon chain of 5 to 14 carbon atoms, or a mixture comprising at least one first linear alkanediol having a carbon chain of 5 to 14 carbon atoms and one or more second linear alkanediols having a carbon chain of 5 to 14 carbon atoms which is different from the first linear alkanediol;
(a^{II}) glyceryl caprylate;
(a^{III}) 4-hydroxyacetophenone;
(a^{IV}) ethyl hexyl glycerin;
(a^{V}) tropolone; and
any mixtures thereof; and
(b) at least one surfactant, preferably wherein the at least one surfactant is selected from the group consisting of nonionic surfactants, anionic surfactants, amphoteric surfactants/zwitterionic surfactants, cationic surfactants, and any mixtures thereof,
and preferably, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols selected from a group consisting of:
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxides;
C10 to C18 N-(alkyl)-N,N-bis(2-hydroxyethyl)amine oxides;
C10 to C18 alkyl amido propyl dimethyl amine oxides;
C10 to C18 alkylbetaines;
C10 to C18 alkylamidobetaines;
C10 to C18 sulfobetaines;
and any mixture thereof;
and any mixture of the above specified cationic, anionic, non-ionic and amphoteric/zwitterionic surfactants.

3. The dish cleaning and rinsing composition according to claim 1, wherein the at least one linear alkanediol or the at least one first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or
wherein the one or more second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

4. The dish cleaning and rinsing composition according to claim 3, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof,
or
wherein the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof;
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol;
a mixture comprising 1,2-tetradecanediol and 2,3-tetradecanediol; or
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol; and
a mixture comprising 1,2-heptanediol and 2,3-nonanediol.

5. The dish cleaning and rinsing composition according to claim 1, wherein the mixture comprising at least one first linear alkanediol and one or more second linear alkanediol comprises the first linear alkanediol and the second alkanediol in a ratio in a ratio of ≥90:10 to 95:5.

6. The dish cleaning and rinsing composition according to claim 1, wherein the at least one enzyme is selected from the group consisting of proteases, lipases, amylases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, ß-glucanases, arabinosidases, hyaluronidases, chondroitinase, oxidoreductases and any mixtures thereof, and preferably the at least one enzyme is selected from the group consisting of protease, lipase, amylase, and any mixtures thereof;
and optionally wherein the composition further comprises at least one enzyme stabilizing agent,
and/or comprising the at least one enzyme in an amount of 0.01% to 2% by weight, based on the total weight of the composition.

7. The dish cleaning and rinsing composition according to claim 1, comprising the at least one boosting agent (a) in an amount of 0.5% to 1.0% by weight, based on the total weight of the composition.

8. The dish cleaning and rinsing composition according to claim 1, comprising the at least one surfactant in an amount of 0.1% to 20% by weight, based on the total weight of the composition.

9. The dish cleaning and rinsing composition according to claim 1, further comprising at least one active substance and/or additive selected from the group consisting of dyes/coloring agents, odor removal/odor capturing agents, soil shielding/soil releasing agents, soil-suspending agents, anti-redeposition agents, ultraviolet light protection agents, fragrances, sanitizing agents, antimicrobial agents and disinfecting agents, water repellency agents, souring agents, mildew removing agents, solubility modifiers and solubilizers, rheology modifiers or thickeners, dispersing agents, water softeners and/or softener salts and/or chelating agents and/or other complexing agents which are added to reduce the hardness of water, buffers, solvents, defoamers/foam inhibitors/suds suppressors, foam stabilizers, bleaching agents, bleach activators, bleach catalysts and/or bleach stabilizers, bleach scavengers, anti-tarnish agents, anti-scalants, anti-corrosion agents/corrosion inhibitors, sequestrant agents, builders, co-builders, salts, binders/fillers, pH-adjusters, stabilizers, hydrotropes, flow control agents, preservatives, detergents and/or other wash-active substances, and any mixtures thereof.

10. The dish cleaning and rinsing composition according to claim 1, comprising an antimicrobial agent selected from the group consisting of benzyl alcohol, methylbenzyl alcohol, phenoxyethanol, and any mixtures thereof.

11. (canceled)

12. (canceled)

13. The dish cleaning and rinsing composition according to 1, formulated as a dish cleaning and rinsing product selected from the group consisting of detergents, rinsing products, combined multiphase products, and mixtures thereof, each of the afore-mentioned in liquid, granule, powder, bar, paste, spray, tablet, gel, or foam form and optionally in two-compartment or multi-compartment form.

14. A method of reducing deposits and/or water spotting on dishes, comprising the steps of
(i) providing a dish cleaning and rinsing composition or dish rinsing composition, comprising at least one surfactant; and
(ii) adding thereto an effective amount of at least one boosting agent (a) selected from the group consisting of
(a^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol as defined in claim 1;
(a^{II}) glyceryl caprylate;
(a^{III}) 4-hydroxyacetophenone;
(a^{IV}) ethyl hexyl glycerin;
(a^{V}) tropolone; and
any mixture thereof.

15. The dish rinsing composition according to claim 2, wherein the at least one linear alkanediol or the at least one first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof;
and/or
wherein the one or more second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

16. The dish rinsing composition according to claim 2, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof,
or
wherein the at least one linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof;
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol;
a mixture comprising 1,2-tetradecanediol and 2,3-tetradecanediol; or
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol; and
a mixture comprising 1,2-heptanediol and 2,3-nonanediol.

17. The dish rinsing composition according to claim 2, wherein the mixture comprising at least one first linear alkanediol and one or more second linear alkanediol comprises the first linear alkanediol and the second alkanediol in a ratio in a range of 90:10 to 95:5.

18. The dish rinsing composition according to claim 2, comprising the at least one boosting agent (a) in an amount of 0.5% to 1.0% by weight, based on the total weight of the composition.

19. The dish rinsing composition according to claim 2, comprising the at least one surfactant in an amount of 0.1% to 20% by weight, based on the total weight of the composition.

20. The dish rinsing composition according to claim 2, further comprising at least one active substance and/or additive selected from the group consisting of dyes/coloring agents, odor removal/odor capturing agents, soil shielding/soil releasing agents, soil-suspending agents, anti-redeposition agents, ultraviolet light protection agents, fragrances, sanitizing agents, antimicrobial agents and disinfecting agents, water repellency agents, souring agents, mildew removing agents, solubility modifiers and solubilizers, rheology modifiers or thickeners, dispersing agents, water softeners and/or softener salts and/or chelating agents and/or other complexing agents which are added to reduce the hardness of water, buffers, solvents, defoamers/foam inhibitors/suds suppressors, foam stabilizers, bleaching agents, bleach activators, bleach catalysts and/or bleach stabilizers, bleach scavengers, anti-tarnish agents, anti-scalants, anti-corrosion agents/corrosion inhibitors, sequestrant agents, builders, co-builders, salts, binders/fillers, pH-adjusters, stabilizers, hydrotropes, flow control agents, preservatives, detergents and/or other wash-active substances, and any mixtures thereof.

21. The dish cleaning rinsing composition according to claim 2 comprising an antimicrobial agent selected from the group consisting of benzyl alcohol, methylbenzyl alcohol, phenoxyethanol, and any mixtures thereof.

22. The dish rinsing composition according to claim 2 wherein the dish rinsing composition is formulated as a dish rinsing product selected from the group consisting of detergents, rinsing products, combined multiphase products, and mixtures thereof, each of the afore-mentioned in liquid, granule, powder, bar, paste, spray, tablet, gel, foam, two-compartment, or multi-compartment form.
